(19) United States
(12) Patent Application Publication
(10) Pub. No.: US 2009/0266516 A1
(43) Pub. Date: Oct. 29, 2009

(54) Electrospray Evaporative Cooling (ESC)

(75) Inventors: Nels E. Jewell-Larsen, Campbell, CA (US); Chih-Peng Hsu, Redmond, WA (US); Alexander V. Mamishev, Seattle, WA (US); Igor A. Krichtafovitch, Kirkland, WA (US); Hsiu-Che Wang, Seattle, WA (US)

Correspondence Address: GARLICK HARRISON & MARKISON, P.O. BOX 160727, AUSTIN, TX, 78716-0727, US

(73) Assignee: UNIVERSITY OF WASHINGTON, Seattle, WA (US)

(21) Appl. No.: 12/430,091

(22) Filed: Apr. 26, 2009

Related U.S. Application Data
(60) Provisional application No. 61/048,508, filed on Apr. 28, 2008.

(51) Int. Cl. F28D 11/06; B05B 5/053; B05B 5/16; F28D 15/00

(52) U.S. Cl. 165/84; 239/706; 239/695; 165/104.21

(57) ABSTRACT

Electrospray evaporative cooling (ESC). Means for effectuating thermal management using electrospray cooling are presented herein. An ESC may be implemented having one or more nozzles situated to spray droplets of a fluid towards a target. Because the fluid may be electrolytic, an electric field may be established between the one or more nozzles and the target can be operative to govern the direction, rate, etc. of the electrospraying between the one or more nozzles and the target. An additional shielding/field enhancement electrode may also be implemented between the one or more nozzles and the target. A droplet movement mechanism may be employed to transport droplets received at a first location of the target so that evaporation thereof may occur relatively more at a second location of the target. An ESC device may be implemented to effectuate thermal management of any of a variety of types of electronic devices.

### CROSS REFERENCE TO RELATED PATENTS/PATENT APPLICATIONS

### Provisional Priority Claims

The present U.S. Utility Patent Application claims priority pursuant to 35 U.S.C. § 119(e) to the following U.S. Provisional Patent Application which is hereby incorporated herein by reference in its entirety and made part of the present U.S. Utility Patent Application for all purposes:

1. U.S. Provisional Application Ser. No. 61/048,508, entitled “Evaporative spray cooling,” (Attorney Docket No. 8010P.1US), filed 04-28-2008, pending.

### BACKGROUND OF THE INVENTION

1. Technical Field of the Invention

The invention relates generally to thermal management; and, more particularly, it relates to thermal management as performed using electrospray and evaporation related mechanisms.

2. Description of Related Art

Thermal management has become a critical design factor in various applications including those that employ high-performance microelectronics. Denser microelectronics architecture and faster microelectronics operational speeds cause ever increasing heat generation. Conventional and prior art cooling technologies directed to address these problems have simply been unable to keep pace with the rapidly progressing microelectronics industry. To effectuate higher speed operation, many newer technologies employ higher supply voltages, operate by consuming higher leveled current signals, etc. and such operational parameters typically contribute to ever-increasing heat generation. Increased heat can have many deleterious effects on the performance of such devices including slower operational rates, reduction in response times, etc. The rate of the advancement of such technologies that operate using higher leveled current signals and producing more heat has outpaced the means in the art to address and combat the ever-increasing heat generated in accordance with such technologies. If the absence of suitable thermal management continues, device performance may suffer and the corresponding life span thereof may be reduced, leading to lack of acceptance in the marketplace. The present means in the art are simply inadequate to meet and address these thermal management needs.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 illustrates an embodiment of an electrospray device showing electrospraying of a fluid onto an electrode surface.

FIG. 2 illustrates an embodiment of an electrospray evaporative cooling (ESC) device using an array of electrospray nozzles.

FIG. 3 illustrates an embodiment of process flow for fabrication of electrospray nozzles: (1) thermal oxidation; (2) 1st photolithography; (3) 1st silicon dioxide etch, top; (4) 2nd photolithography; (5) 2nd silicon dioxide etch and 1st DRIE, bottom; and (6) 2nd DRIE.

FIG. 4 illustrates an embodiment of a closed-loop system that is operative to perform electrospray cooling.

FIG. 5 illustrates an embodiment of an apparatus that is operative to measure heat flux (qs) and heat transfer coefficient (h) for micro-fabricating an ESC device.

FIG. 6 illustrates an embodiment of a one stage ESC device.

FIG. 7A, FIG. 7B, and FIG. 7C illustrate various embodiments of a one stage ESC device.

FIG. 8 illustrates an embodiment of a two stage ESC device.

FIG. 9A, FIG. 9B, and FIG. 9C illustrate various embodiments of a two stage ESC device.

FIG. 10 illustrates an embodiment of a top view of an ESC device.

FIG. 11 illustrates an embodiment of top view of an electrospray array with a coupled guard ring.

FIG. 12 illustrates an embodiment of a closed loop ESC device.

FIG. 13 illustrates an alternative embodiment of an ESC device.

FIG. 14 illustrates an embodiment of a high density stacked array for electrospray cooling.

FIG. 15 illustrates an embodiment of flow inside of a droplet.

FIG. 16 illustrates an embodiment of a droplet on a surface with chemical gradient.

FIG. 17 illustrates an embodiment of an ESC device that includes one or more droplet movement mechanisms.

FIG. 18 illustrates an embodiment of an ESC device that includes a vibrator based droplet movement mechanism.

FIG. 19 illustrates an embodiment of movement of a droplet induced by vibration of a surface.

FIG. 20 illustrates an embodiment of an ESC device that includes a textured surface based droplet movement mechanism.

FIG. 21 illustrates an embodiment of movement of a droplet on a textured surface.

FIG. 22 illustrates an embodiment of a top view of textured surface that is operative to effectuate droplet movement.

FIG. 23A illustrates an embodiment of an ESC device that includes a coupler and is operative to couple to an integrated circuitry.

FIG. 23B illustrates an embodiment of an ESC device that is integrated within an integrated circuitry.

FIG. 24A illustrates an embodiment of a method for performing electrospray evaporative cooling.

FIG. 24B, FIG. 25A, and FIG. 25B illustrate alternative embodiments of a method for performing electrospray evaporative cooling.

### DETAILED DESCRIPTION OF THE INVENTION

A novel means for performing thermal management is presented herein. This thermal management may be performed in accordance with electronic devices. Various embodiments for performing thermal management in microelectronic application and, more particularly, embodiments for using electrospray evaporative cooling (ESC) for high heat flux transfer in microelectronics and micro-electrical mechanical systems (MEMS) are presented herein. In recent years, the rapid development of microelectronic devices and other electronic devices has led to an increase component density at both chip (e.g., integrated circuit (IC)) and board levels. Within this decade, the size of a single transistor gate expects to decrease in size to about 25 nm, and the number of transistors in common ICs expects to be in the number of billions (e.g., 10⁹).

This ongoing development will, in turn, amplify an already existing problem therein, which is that each semiconductor component implemented within an electronic device emits heat associated with its intrinsic electrical impedance, leading to an even larger heat flux emitted from the same surface area. That is to say, an IC fabricated with today's technology and having a particular size will typically generate and emit more heat that a commonly sized IC fabricated using prior fabrication techniques.

To address such increasing thermal related challenges, thermal management technology needs to develop far beyond traditional cooling mechanisms and provide for cooling solutions that have the ability to remove ever-increasing heat flux densities (e.g., a greater amount of heat being emitted from a same sized area), while simultaneously allowing for optimization for a particular application. As such, efficient thermal management has become a point of focus for the electronics industry which, among other goals, is trying to satisfy the escalating market demand for products.

Due to its capability to dissipate high heat fluxes, evaporative spray cooling as performed in accordance with the principles presented herein, and their equivalents, is perhaps the most promising cooling and thermal management solution such as may be employed within microelectronic and other electronic applications.

In particular, two-phase evaporative spray cooling is highly desirable because of its high heat flux removal capability. The heat transfer mechanism of spray cooling may generally be divided into three parts, namely, (1) nucleate boiling due to both surface and secondary nucleation, (2) convection heat transfer, and (3) direct evaporation from the surface of the liquid film. In the spray chamber, the slightly sub-cooled droplets impinge onto the hot surface. A large part of the droplets turn into a thin film on the hot surface and a small part of them vaporize, removing the heat through phase change.

Spray cooling offers cooling rates that are orders of magnitude higher than other common/prior art cooling methods. Heat fluxes for evaporative spray cooling on the order of 1000 W/cm² is possible, while the maximum heat flux reported for forced convection air and natural liquid cooling are on the order of only 0.2 W/cm² and 3 W/cm², respectively.

These significantly larger heat transfer rates such as may be achieved in accordance with evaporative spray cooling are achieved, at least, through the combination of using conduction in accordance with a solid-liquid interface and evaporation, i.e., phase change from liquid to gas. Due to fast transferring thermal energy through evaporation to low temperature region in the system, a large amount of heat can be removed in an extremely short period. In one embodiment of this novel technique, the cooling fluid is pressurized by a mechanical pump and ejected through one or more nozzles. Any of a wide variety of types of cooling liquids may be employed without departing from the scope and spirit of the invention, including though not limited to: water, ethanol, various water/ethanol mixtures, etc.

The fluid is then atomized and accelerated towards and/or onto a warmer/hot solid surface. As the liquid droplets move towards the solid-fluid interface, some of the droplets evaporate while the others spread into a thin-fluid film absorbing thermal energy from the warmer/hot solid surface.

The electrospray approach presented herein may employ an evaporative spray for use in cooling electronics. In accordance with this novel cooling approach, any desired spray techniques (e.g., electrospray means alone, pressure-related mechanical means alone, a combination of electrospray means in conjunction with some pressure-related mechanical means, etc.) may be employed to achieve cooling fluid atomization by driving fluid at desired pressures (e.g., high pressure in some embodiments) through one or more spray nozzles.

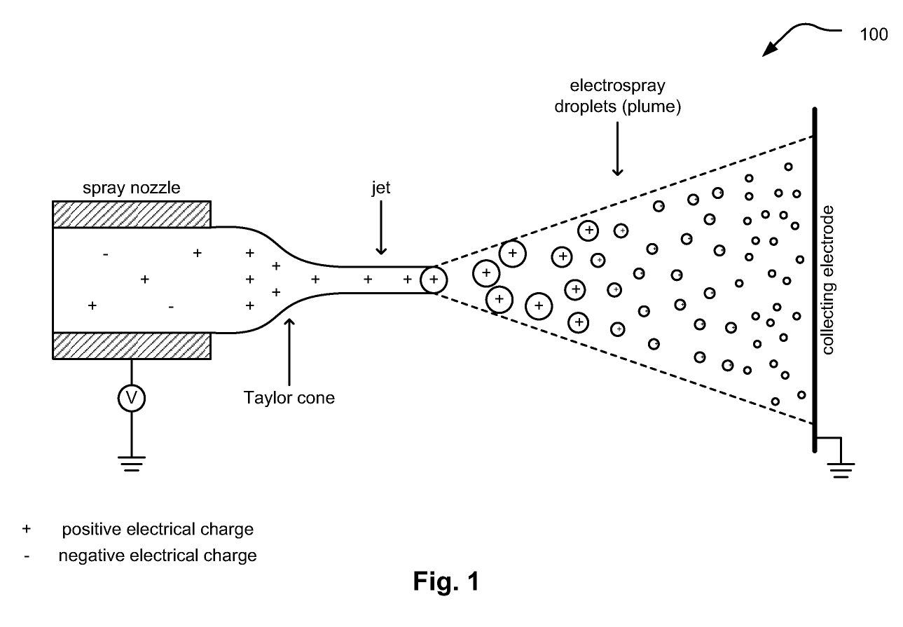

FIG. 1 illustrates an embodiment of an electrospray device 100 showing electrospraying of a fluid onto an electrode surface. In electrospray systems, a suitable fluid is passed through a nozzle placed at some distance from a collecting electrode, as shown in FIG. 1. When a voltage is applied between the nozzle and the collecting electrode, charges within the fluid (e.g., being at least weakly electrolytic in nature, being a fluid having at least some conductivity) are forced to the surface of the fluid thereby forming a meniscus at the end of each nozzle. As the applied voltage magnitude increases (as shown by voltage supply showing encircled V), the electric field strength and charge density at the surface of the meniscus at the end of each nozzle increase as well. Based on a voltage difference between the applied voltage magnitude and a voltage of the collecting electrode (e.g., ground in this embodiment), any one or more of a number of operational parameters corresponding to the emission of the droplets from the nozzles may be affected. Some examples of these operational parameters include a rate of emission of the droplets emitted from the nozzle, a size of the droplets emitted from the nozzle, a distribution or uniformity of the droplets emitted from the nozzle, etc.

The Columbic force acting onto the charges in the fluid causes the fluid meniscus to deform into the shape of a cone, known and also depicted as a Taylor cone. At the critical electric field intensity, the forces on the charged fluid in the Taylor cone overcome the intra-molecular forces of the fluid, and a jet of charged liquid is sprayed from the tip of the cone. The charged fluid particles expelled from the tip of the fluid cone repel each other, generating fine aerosol droplets. The charged droplets accelerate in the electric field and travel toward the collecting electrode, impinging on its surface (e.g., which has an associated thermal exchange surface). The charges are stripped from fluids at the thermal exchange surface, and the droplets are evaporated or form into a thin fluid film, thereby removing thermal energy from the surface.

In one embodiment, combining electrospray with corona discharge may help to enhance airflow circulation from the spray nozzle to the collecting electrode and perhaps helps clear vapor from the chamber. In an embodiment where “closed loop fluid return method” is executed (many embodiments of which are described below), for low flow rates, capillary flow may be sufficient. However, in another embodiment, a mechanical pump can be used or other EHD pumps may be used that might use the same HV power supply.

In various embodiments, one or more components of an electrospray device include a nozzle, nozzle array, high voltage contacts, field enhancement electrodes, target electrode, power supply, fluid properties (conductivity, surface tension, freezing point, toxicity hazard, long term stability under high electric field, viscosity, heat capacity), fluid reservoir, method to ensure same flow through each nozzle or at least a specified flow through each nozzle, suitable flow rate per area and per nozzle, suitable droplet size, suitable droplet velocity at impact with surface, vapor path away from surface, ensuring droplet arrival to surface against vapor, and minimizing droplet heating from vapor.

While many of the embodiments described herein operate to emit droplets from a source (e.g., one or more nozzles) based on an established electric field between the source and a target (e.g., a collecting electrode or thermal exchange surface), it is also noted that a mechanical means may be employed to emit droplets from the source based on pressure (e.g., such as by using a mechanical pump as described in other embodiments) or based on some other means. For example, it is noted that such a pressure-related mechanical means may be implemented instead to control the emission of droplets from the one or more nozzles (i.e., in place of and instead of the voltage difference established between the applied voltage magnitude and the collecting electrode). Also, in other embodiments, such a pressure-related mechanical means may operate in conjunction with the established electric field between the applied voltage magnitude and the collecting electrode, such that two (or even more) control means are employed in combination to govern the emission of the droplets from the source.

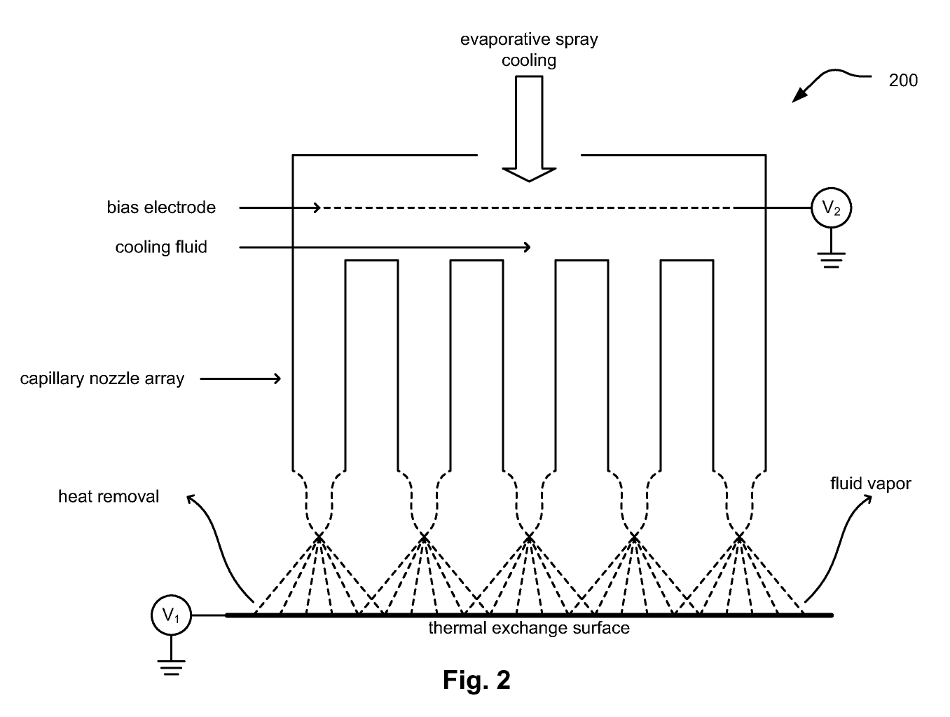

FIG. 2 illustrates an embodiment of an electrospray evaporative cooling (ESC) device 200 using an array of electrospray nozzles. The concept of ESC is shown in FIG. 2 where an array arrangement of nozzles enables electrospray impingement over a large thermal exchange surface. The size of the array of the electrospray nozzles may be scaled to any particularly desired size. Moreover, a desired array of multiple ESC devices may also be implemented such that multiple, cooperatively (or independently) operating ESC devices may operate to perform thermal management of a much larger surface area (e.g., using some multiplexed scheme of more than one ESC device as referenced below).

Tight control of droplet size and distribution (uniformity of droplets) is possible, allowing for optimization of droplet size to maximize heat transfer rates. Droplets can be directed to a desired location by tailoring the external electric field, making it suitable for non-uniform heat flux applications, such as CPUs. Although flow rates in common electrospray applications are relatively small, significant flow rates can be achieved through the multiplexing of multiple micro nozzle arrays in an array. Electrospray atomization of the cooling fluid and transportation of the droplets to the surface is achieved using Columbic forces rather than using high mechanical stress in accordance with prior art approaches, and this operates to reduce significantly the size, cost, and power of a fluid pumping system that performs cooling.

Electrospray flow rates of 1.67×10⁻⁴ cc (cubic centimeter) per second from a single 100 μm (micrometer) micro-fabricated nozzle have been demonstrated. Assuming a relatively sparse array of 500 nozzles per cm², a total flow rate of 0.083 cc per second can be achieved. Also, assuming values of a density and heat of vaporization of 789 kg/m³ (kilograms per cubic meter) and 838 kJ/kg (kilo-Joules per kilogram), respectively, and assuming that the entire flow volume evaporates, the vapor would remove 55.1 W (Watts) from the 1 cm² surface. One of the largest markets for thermal management solutions today is focused on CPU cooling. Most CPU packages today have a total design power of 50 W to 150 W depending on the application. CPU packages are generally at least several cm², therefore a heat transfer rate near 50 W per cm² would be sufficient even without using a heat exchange area larger than the package footprint.

Also, as described below in other embodiments, when electrospray and evaporation of droplets operate simultaneously within a shared region, the vapor stream generated by the evaporated cooling fluid may act to impede the electrospray particles as they travel towards the target surface. For example, a recent evaporative spray study that utilized a thermal ink jet (TIG) printing head to generate the fine particles, the maximum thermal transfer from the device was negatively impacted by vapor impediment of the cooling electrospray. The TIG device relied essentially on gravity to draw the particles to the target surface, so they were easily impeded by the rising vapor.

In the proposed electrospray evaporative cooling approaches presented herein, however, the charged spay particles are constantly accelerated towards the surface in the electric field, and should only be minimally impacted by the vapor (i.e., the evaporation of the droplets from the thermal exchange surface). Furthermore, an ESC device can be designed to compensate for vapor impediment by modulating the electric field intensity to apply more or less force to the sprayed particles. Moreover, one or more droplet movement mechanisms may also be employed to compensate for vapor impediment as well (also explained elsewhere herein).

For proper electrospray operation, a high intensity high gradient electric field is generated at the tip of the fluid meniscus at the output of the spray nozzle. A finite element modeling approach can be used to model the hydrodynamic pressure drop and electric field profile and intensity around the electrospray nozzle for multiple nozzle geometries and array patterns. For example, the Comsol Multiphysics modeling suite can be used for that purpose.

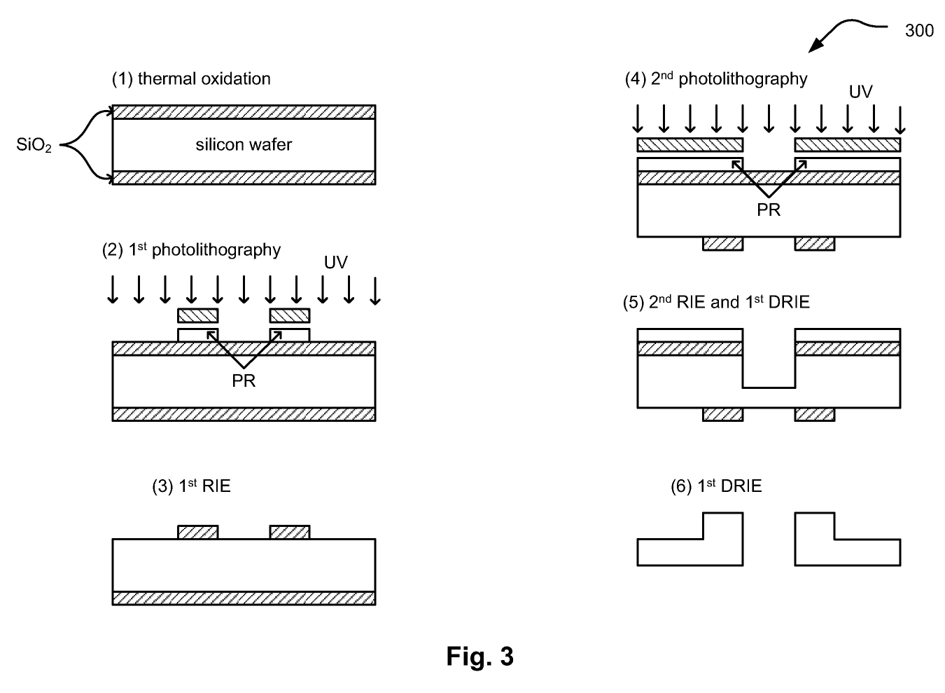

FIG. 3 illustrates an embodiment of process flow 300 for fabrication of electrospray nozzles: (1) thermal oxidation; (2) 1^{st} photolithography; (3) 1^{st} silicon dioxide etch, top; (4) 2^{nd} photolithography; (5) 2^{nd} silicon dioxide etch and 1^{st} Deep Reactive Ion Etching (DRIE), bottom; and (6) 2^{nd} DRIE.

In this embodiment, the micro-nozzle array is micro-fabricated in double-side polished single crystal silicon wafers. Deep Reactive Ion Etching (DRIE) is used to micro-fabricate the features of the device as depicted in FIG. 3. Any suitable micro-fabrication and microscopy equipment can be used for fabrication of an ESC device in accordance with the principles presented herein, including, though not limited to, oxidation furnace, spinner, hexamethyldisilazane (HMDS) oven, AMB aligner, barrel etcher, Reactive Ion Etching (RIE), and DRIE.

Both closed loop and open cooling systems are possible with ESC-based thermal management. An exemplary closed loop system approach is described herein, which facilitates the use of fluids with the most favorable physical properties, and in part because such a design is suitable for any of a variety of targeted applications (e.g., high performance mobile communication devices, desktop computing devices, etc.).

In various embodiments connected with a closed loop system, one or more components of such an ESC device include the vapor path from the target to condenser, the method of condensing, pressure and atmosphere (air pressure) within closed loop system at equilibrium, method of transporting liquid from condensed vapor back to nozzle array, fluid/materials that do not interact with each other, and filter of fluid over time.

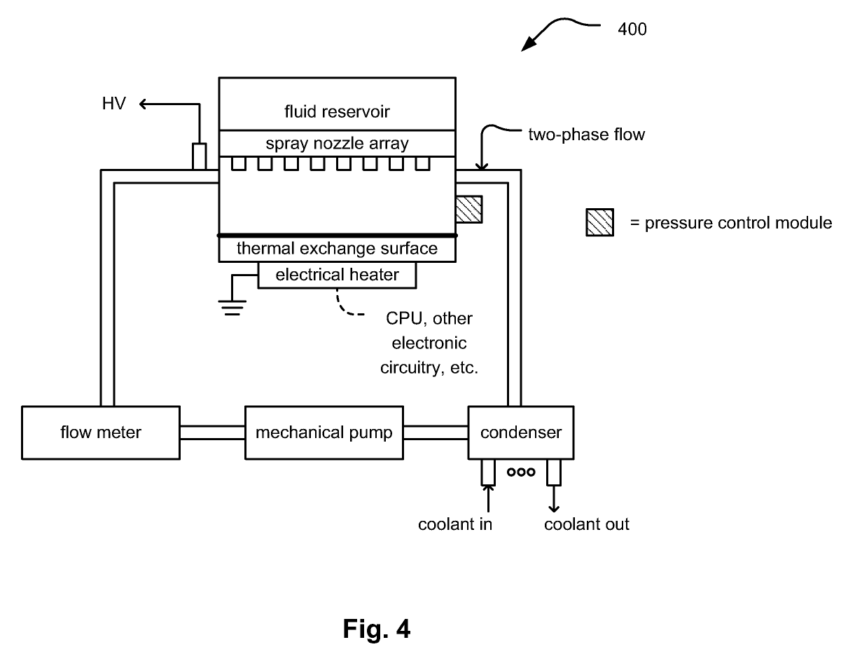

FIG. 4 illustrates an embodiment of a closed-loop system 400 that is operative to perform electrospray cooling.

There are five parts of this embodiment of a micro-nozzle ESC cooling apparatus, as shown in FIG. 4: (1) the micro-nozzle cooling array; (2) the collecting electrode, which is associated with and acts as a thermal exchange surface in this case; (3) the biasing electrode; (4) the vapor condenser; and (5) the fluid return pump and path. The micro-nozzle cooling array is attached to the bottom of a small fluid reservoir that is pressurized by the fluid return pump.

The biasing electrode is connected with the fluid reservoir directly above the nozzles and serves dual roles. The first role is to bias the fluid electrically with respect to the collecting electrode, and the second role is to act as a flow homogenizer and maintain equal flow rates through each nozzle. The collecting electrode is located beneath the nozzles and is attached to the object requiring cooling. In operation, with a bias voltage above electrospray onset, a spray of fine droplets impinges on the collector surface and evaporates. The fluid vapor created during operation is channeled to the vapor condenser, where the vapor exchanges heat through a heat sink to the ambient (or to a cooler environment) and condenses. The fluid from the condensed vapor is collected in a small reservoir and fed back to the nozzle array by the fluid return pump closing the loop.

The heat flux can be measured using a standard constant heat flux measurement method. A thin copper plate may act as the collector electrode and will be attached thermally to a known heat source (e.g., CPU, other electronic circuitry, etc.), and the copper plate is thermally insulated from all surfaces except the collecting surface. A heat source of known power can be applied to the opposite side of the plate, and its temperature distribution may be monitored using embedded thermocouples.

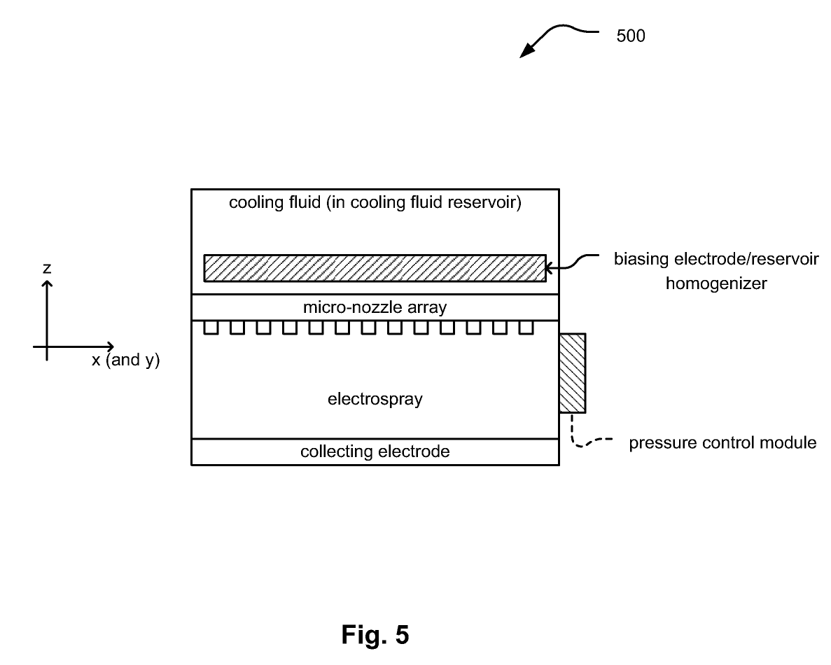

FIG. 5 illustrates an embodiment of an apparatus 500 that is operative to measure heat flux (qs) and heat transfer coefficient (h) for micro-fabricating an ESC device.

The micro-nozzle ESC cooling apparatus, shown in FIG. 5, can be positioned above the collecting electrode, cooling the collecting surface/copper plate. Thermocouples can be spaced at predetermined locations between the heat source and the bottom surface of the copper plate to measure the mean copper plate temperature. By regulating the input power of the heat source for a given mean temperature, the heat removal rate of the ESC device can be calculated.

During the final characterization experiments, ESC device current and voltage will be measured and used to calculate power consumption and heat removal effectiveness. The heat flux, heat transfer coefficient, power consumption and heat removal effectiveness will be used to compare this device with other similar cooling systems, as well as to validate numerical modeling efforts. Thermal camera imaging may be employed to take images of working surfaces in order to verify device performance and extract data for further analysis.

Any suitable fluid selection can be used depending on their fluidic properties, including electrical conductivity, surface tension, and boiling point. In order to generate fine small droplets at low applied voltages, a suitable fluid has low surface tension. The low boiling point, in turn, enables fast heat removal from the heated surface through evaporation. One suitable fluid includes HFE-7100 which meets many requirements. Alternatives include ethanol and water.

To suitably control the pressure accurately, a small diameter vessel is utilized, and a stepper motor actuated piston can be used to control fluid flow rate from a container. The resultant ESC device is likely to work over a fairly large range of flow rates and back pressures. Unlike droplet-on-demand piezoelectric devices, the forces being applied to atomize the fluid are relatively constant, and although a small change in flow rate will have a small impact on droplet size, the system should be relatively forgiving.

In various embodiments that employ an ESC device, at small superheat, the heat transfer may occur by using small droplets and the high percentage of surface saturation to obtain a thin liquid film for better heat transfer. The term “nozzle” means the inclusion of a traditional tube type nozzle; a double-walled nozzle to help deliver non-electrosprayable materials to the surface with an electrosprayable outer coating (possibly useful in an open environment or virtual double wall where one fluid is forced through a fluid on the surface dragging it with it); made of a conductive material so that nozzle generates a corona; made of a semiconductor material or insulating material; can protrude from the surface plane to create a sharp field at the nozzle tip; can be created by a capillary tube embedded within a dielectric material, where the end of the tube is flush with or inset into the surface plane and in the case of an array, multiple capillary tubes could be embedded as an array into the dielectric material; can be created by having a solid mound which has a hydrophilic coating that causes the electrosprayable fluid to wick up onto the nozzle surface, with the Taylor cone being formed at the top of the nozzle structure and this potential eliminates the problem of clogging that may appear in “tube” like nozzles; could use brush like design, where capillary forces carried fluid through or on the surface of many nozzles in parallel; could have axial round brush that rotates into and out of a fluid bath delivering new wetted bristles to the electrospray region of the device. (electrostatic pulse, mechanical motor, electrospray/ionic wind propulsion, which bristles can be bent such that vector of propulsion force is delivered in a manner which best rotates the brush and which mutual location of the active region of the brush and the direction of the propulsion force can be such to enhance brush rotation about its axis; could be an elongated tube opening/hollow razor shaped like the cross section of a droplet.

Any of a wide variety of means may be employed to fabricate a nozzle or nozzle array for use in an ESC device. For example, a “flexible nozzle” may be fabricated using deep reactive ion etching (DRIE) or X-ray lithography for patterning high aspect ratio nozzles and which capillary array from glass or other dielectric may be fabricated by a “drawn” technique. It is noted that a nozzle array may be interpreted to include a unit cell concept, where each nozzle or set of nozzles is electrically shielded from the next one. This way the relative position between nozzles does not interfere with the electric field distribution of the next. Alternatively, in other embodiments, the many nozzles of the array may be corporately shielded together. Also, the term flexible nozzle array may be interpreted to include the functionality of self alignment based on the mutual repulsion due to the electrostatic field.

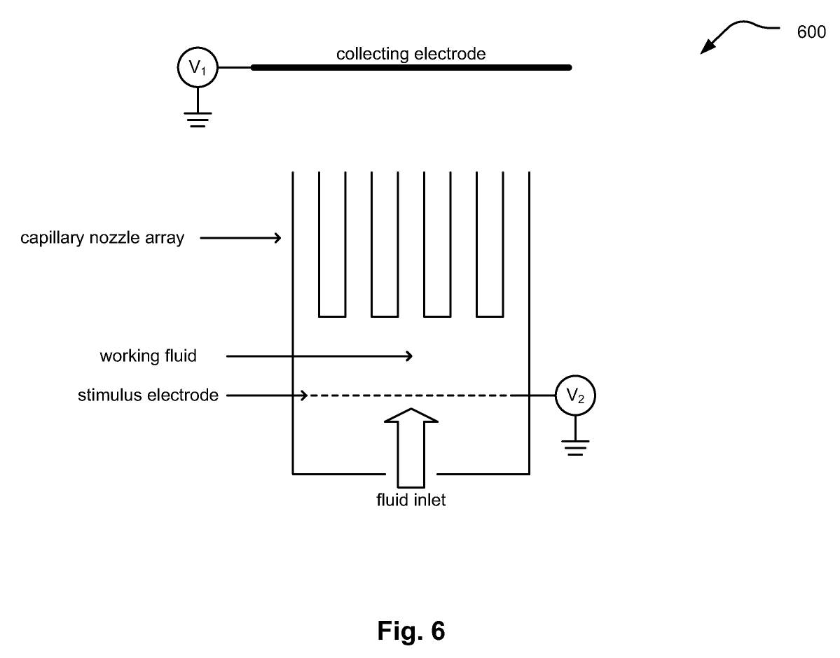

FIG. 6 illustrates an embodiment of a one stage ESC device 600. A stimulus electrode and a collecting electrode operate to establish an electric field between one or more nozzles (shown in this embodiment as a capillary nozzle array) so that fluid having electrolytic properties will be drawn appropriately in the direction of the electric field. The collecting electrode is implemented at or near the thermal exchange surface. A reservoir holding the working fluid (i.e., the fluid having the electrolytic properties) receives fluid and serves to provide the fluid to the one or more nozzles for effectuating electrospray towards the thermal exchange surface associated with the collecting electrode.

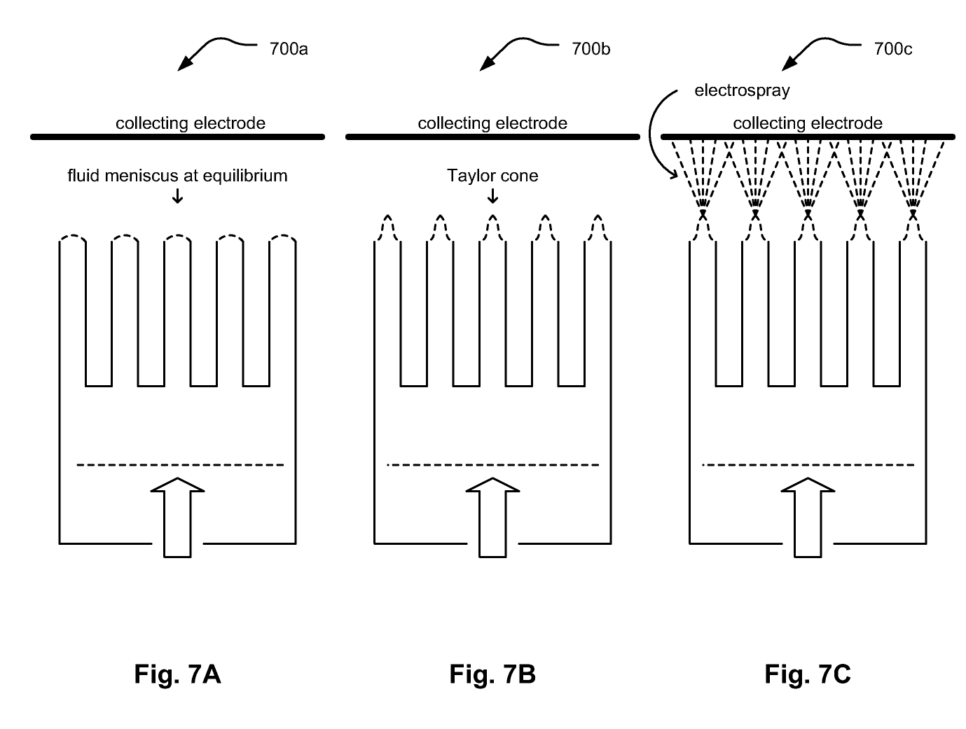

The following three diagrams (FIG. 7A, FIG. 7B, and FIG. 7C) show some of the various steps/phases that occur in accordance with electrospraying. These following three diagrams may be viewed based on the nomenclature and components depicted within FIG. 6.

FIG. 7A, FIG. 7B, and FIG. 7C illustrate various embodiments of a one stage ESC device.

Referring to one stage ESC device 700a of FIG. 7A, a fluid meniscus is formed at each of the nozzles within nozzle array at equilibrium. When a voltage is applied between the nozzle and the collecting electrode, charges within the fluid are forced to the surface of the fluid meniscus of each nozzle. At this point, there are no Taylor cones formed at the ends of each nozzle, and there is no electrospraying yet occurring within the region between the stimulus electrode, the nozzle array, and the collecting electrode.

Referring to one stage ESC device 700b of FIG. 7B, as the electric field between the stimulus electrode and the collecting electrode continues to grow, A Taylor cone is formed and extends from a nozzle within the nozzle array. In other words, as mentioned above, as the applied voltage magnitude increases, the electric field strength and charge density at the surface increase as well. The Columbic force acting onto the charges in the fluid causes the fluid meniscus to deform into the shape of a cone, known as a Taylor cone.

Referring to one stage ESC device 700b of FIG. 7C, at the critical electric field intensity, the forces on the charged fluid in the Taylor cone overcome the intra-molecular forces of the fluid, and a jet of charged liquid is sprayed from the tip of the Taylor cone towards the thermal exchange surface associated with the collecting electrode. The charged fluid particles expelled from the tip of the fluid cone repel each other, generating fine aerosol droplets. The charged droplets accelerate in the electric field and travel toward the collecting electrode, impinging on its surface. The charges are stripped from fluids at the thermal exchange surface, and the droplets are evaporated or form into a thin fluid film, removing energy from the surface.

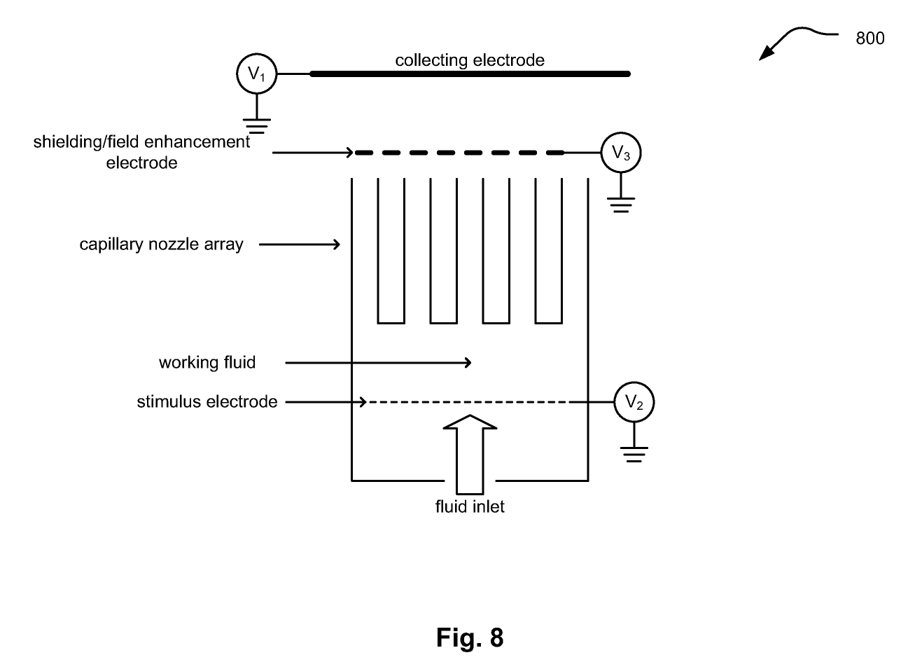

FIG. 8 illustrates an embodiment of a two stage ESC device 800. Several of the embodiments presented herein show a stimulus electrode separated from a collecting electrode to operate cooperatively for the establishing of the electric field there between. In this embodiment of a two stage ESC device 800, one or more additional shielding/field enhancement electrodes may also be implemented between the stimulus electrode and the collecting electrode (e.g., in the region between the stimulus electrode and the collecting electrode). The use of such a shielding/field enhancement electrode allows for a larger number of nozzles to be packed within a relatively smaller area (e.g., packed more closely together).

Any of a wide variety of configurations may be implemented using one or more shielding/field enhancement electrodes to modify the electric field extending between the nozzle and the thermal exchange surface associated with the collecting electrode. Also, the placement of such one or more shielding/field enhancement electrodes between the stimulus electrode and the collecting electrode may be selected based on a particular application. Moreover, the signals provided to these one or more shielding/field enhancement electrodes may also be different depending on a particular application. In many embodiments, a constant/fixed/DC voltage signal is provided to a shielding/field enhancement electrode. However, in some embodiments, where multiple shielding/field enhancement electrodes are implemented between the stimulus electrode and the collecting electrode, different signals may be provided to each of the respective shielding/field enhancement electrodes so that they are energized differently and operate differently.

Of course, it is also noted that any embodiment that employs a stimulus electrode and the collecting electrode may likewise include more than one stimulus electrode and more than one collecting electrode, and each respective stimulus electrode and each respective collecting electrode may be provided different signal so that they are energized differently and operate differently from one another.

Referring again to FIG. 8, this embodiment shows how at least one shielding/field enhancement electrode may be implemented between the stimulus electrode and the collecting electrode to modify the electric field established there between in accordance with some desired manner. In some instances, a shielding/field enhancement electrode is employed to control droplet formation (e.g., those droplets emitted from one or more nozzles) in terms of their size and density. The spray rate may also be modified by using a shielding/field enhancement electrode; the speed by which such droplets are provided to the thermal exchange surface may be modified using a shielding/field enhancement electrode. Certainly, other operational parameters of such an ESC device may also be modified by using a shielding/field enhancement electrode.

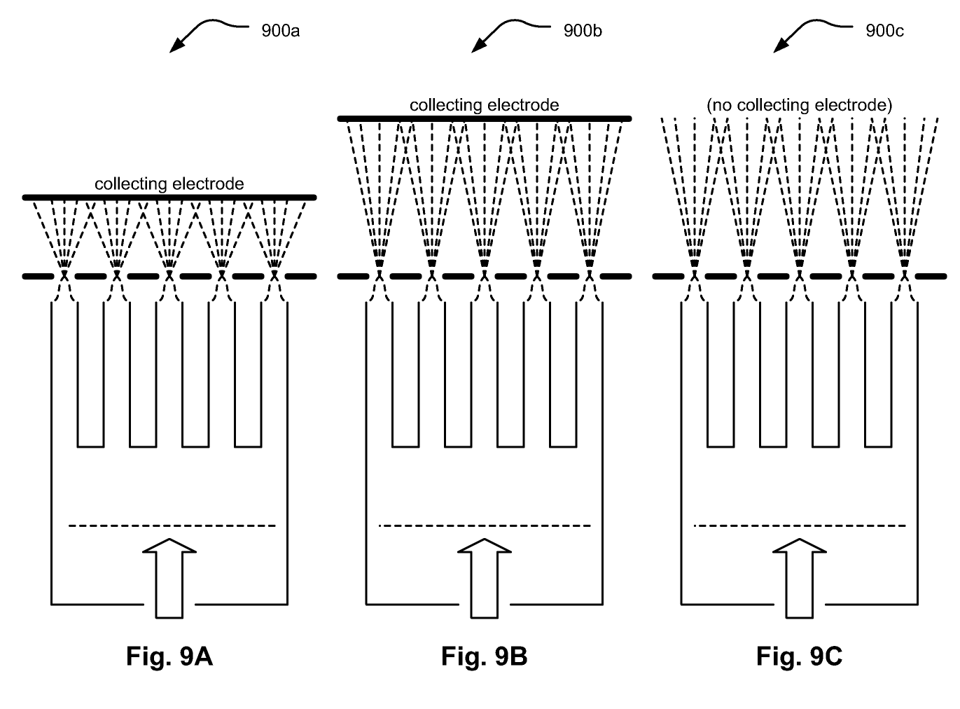

The following three diagrams (FIG. 9A, FIG. 9B, and FIG. 9C) show some possible structural variations that may be employed in alternative embodiments of a two stage ESC device. In each of these embodiments, the shielding/field enhancement electrode is shown as being a particular distance from the nozzle array of the respective two stage ESC device. Of course, it is noted that the distance between the shielding/field enhancement electrode and the nozzle array is yet another structural modification that may be varied in certain embodiments. Moreover, it is noted that such a shielding/field enhancement electrode may be implemented using position varying mechanism, so that the position of the shielding/field enhancement electrode may be modified, in real time, within such a two stage ESC device. However, in many embodiments, the modulation of the electrical signal(s) provided to the one or more shielding/field enhancement electrode will be operative to perform the appropriate modification of the electric field between the stimulus electrode and the collecting electrode.

FIG. 9A, FIG. 9B, and FIG. 9C illustrate various embodiments of a two stage ESC device.

Referring to one stage ESC device 900a of FIG. 9A, this embodiment shows a collecting electrode be implemented relatively closer than the collecting electrode of the embodiment of a one stage ESC device 900b shown in FIG. 9B, and each respective embodiment includes a shielding/field enhancement electrode implemented between the stimulus electrode and the collecting electrode.

Referring to one stage ESC device 900b of FIG. 9C, no collecting electrode whatsoever is implemented within this embodiment. The electric field of this embodiment is established between the stimulus electrode and a shielding/field enhancement electrode. In that there is no collecting electrode associated with a thermal exchange surface in this embodiment, the electrospray is provided to the thermal exchange surface based on pressure by which the fluid is emitted from the nozzle array, the electric field established between the stimulus electrode and the shielding/field enhancement electrode, etc.

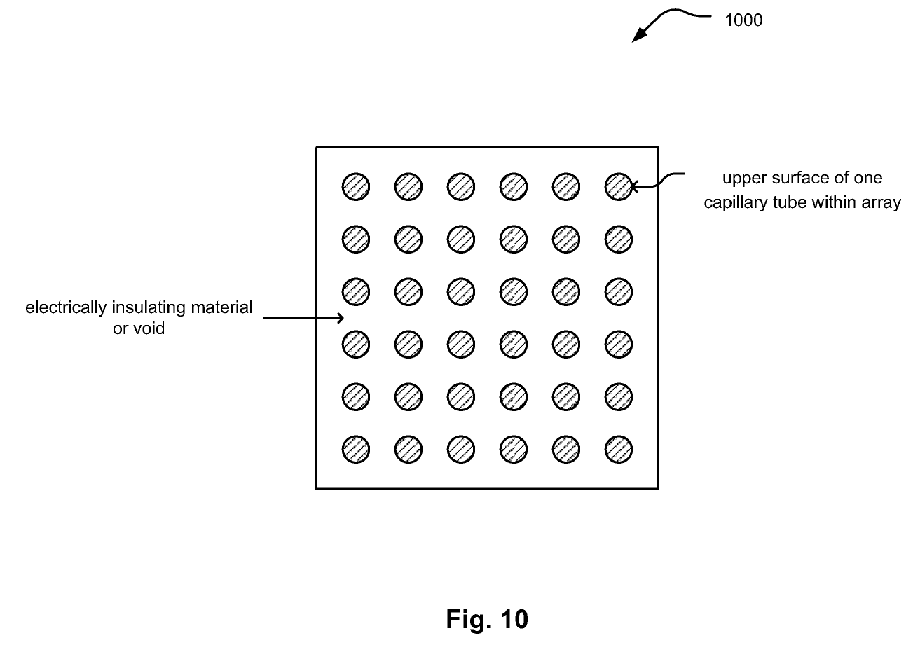

FIG. 10 illustrates an embodiment 1000 of a top view of an ESC device. This diagram shows a number of nozzles in a nozzle array configuration being composed of and constructed of a common material (e.g., a dielectric material in many embodiments). It is note that the pattern/arrangement of the nozzles of a nozzle array may have any desired form (e.g., nozzles arranged in concentric circles, nozzles arranged in a square pattern format as depicted in this particular diagram, or in any desired pattern) without departing from the scope and spirit of the invention.

This diagram shows the ends of each of the nozzles align along a surface of the common material. In such an embodiment, rather than have a number of nozzles extended outward from a nozzle array chassis, the nozzles themselves may be constructed so as not to protrude outward whatsoever. The ends of the nozzles of the nozzle array align along a surface of the common material and provide for greater mechanical robustness. Moreover, the associated complexity and cost of fabrication of such a flush mounted nozzle array are typically much less than using some silicon fabrication means to construct a nozzle array having nozzles whose ends extend outwards from the construct.

Viewing the nozzle array chassis from one perspective, each of the nozzles of the nozzle array is a corresponding tunnel through the chassis. These tunnels functional operate as appropriate capillary tubes by which the associated Taylor cones may be generated in accordance with electrospraying.

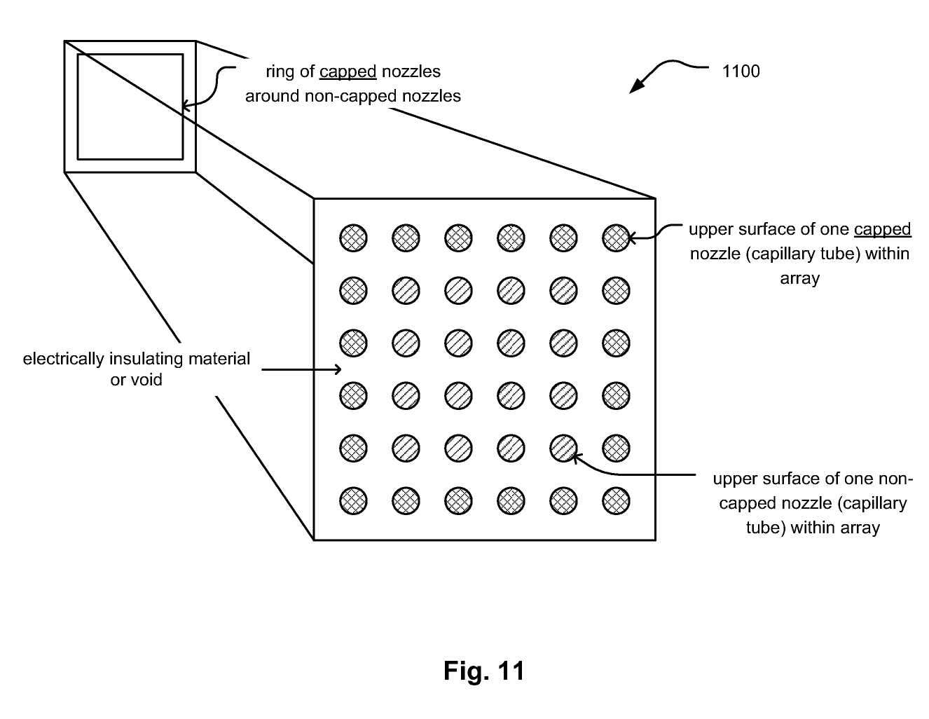

FIG. 11 illustrates an embodiment 1100 of top view of an electrospray array with a coupled guard ring. This coupled guard ring facilitates the generation of a uniform spray across all nozzles of the nozzle array by having a congruent electric field at each spraying nozzle. Nozzles at the perimeter of the nozzle array are electrically exposed, and the nozzles at the center of the nozzle array are electrically shielded. A perimeter of ‘false’ nozzles, which do not spray and may be capped/sealed off, operate to shield the perimeter of the functional/spraying nozzles such that they have similar electric field characteristic as all other spraying nozzles. It can be seen that a ring of capped nozzles is implemented around the non-capped/operational and spraying nozzles of the nozzle array.

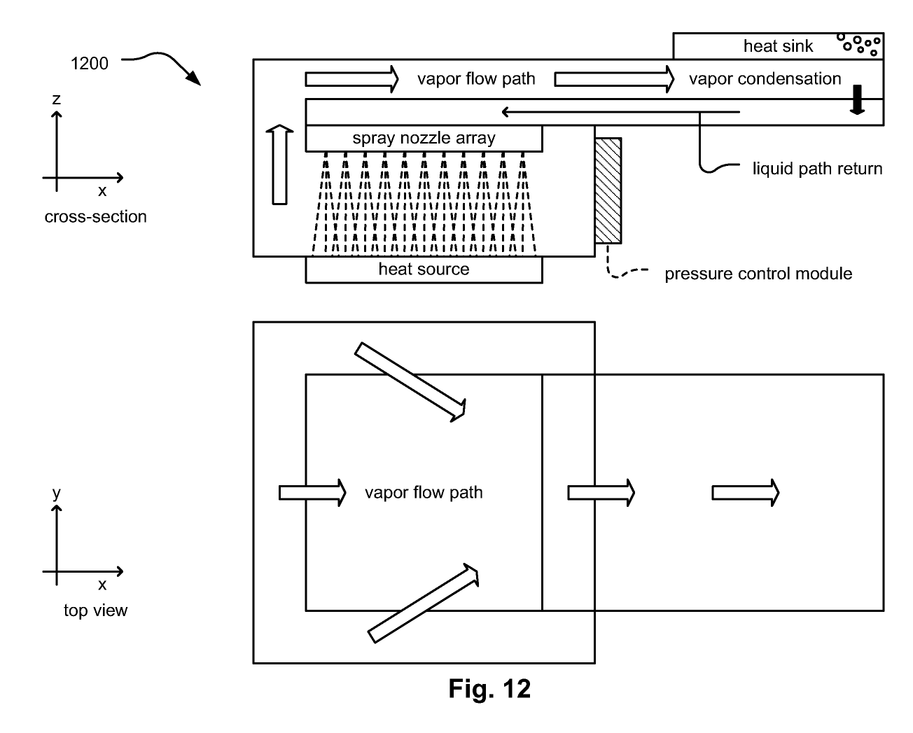

FIG. 12 illustrates an embodiment of a closed loop ESC device 1200. This embodiment includes a spray nozzle array that electrosprays droplets of a fluid toward a heat source (e.g., some type of electronic component such as a central processing unit CPU, some other type of integrated circuitry, or any other type of heat source). Being a closed loop system, the evaporation of the droplets is directed along the vapor flow path towards a heat sink in which vapor condensation is performed to capture the liquid for subsequent use in accordance with electrospraying.

If desired, as within other embodiments, a pressure control module, coupled to or integrated with the enclosed chamber of such a closed loop ESC device 1200, may be implemented to modify air pressure within the enclosed chamber of the closed loop ESC device 1200. In some embodiments, the air pressure is lowered (e.g., less than 1 atmosphere) within the enclosed chamber so as to create a partial vacuum therein. The modification of air pressure within such an enclosed chamber is yet another operational parameter that may be employed to govern operation of such an ESC device.

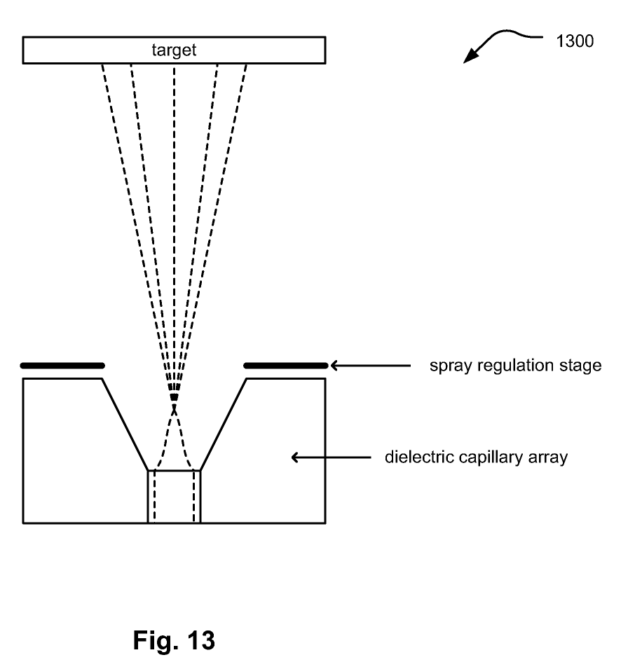

FIG. 13 illustrates an alternative embodiment of an ESC device 1300. This embodiment shows an electrospray nozzle that is recessed into a dielectric material within a two stage ESC device. This diagram shows just one nozzle within a dielectric capillary array that includes more than one nozzle. The spray regulation stage operates to provide an electric field having desired characteristics. This established electric field having is operative to generate electrospray having desired characteristics between the Taylor cone and the spray regulation stage. The velocity of the spray is then regulated by the potential (voltage difference) between the target and the spray regulation stage.

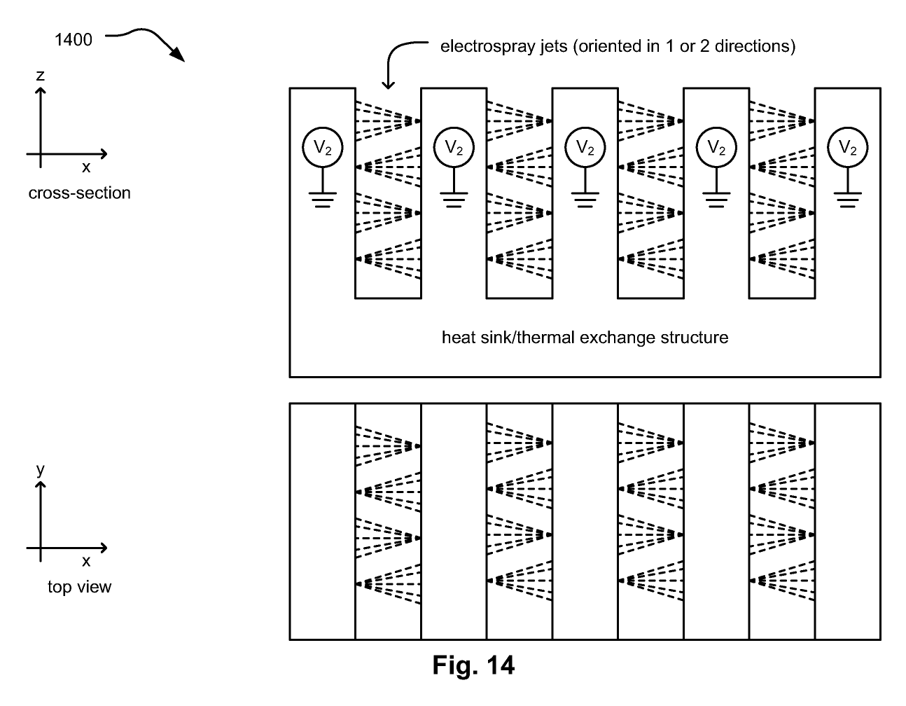

FIG. 14 illustrates an embodiment of a high density stacked array for electrospray cooling 1400. Because of the very small scale by which electrospray nozzles may be fabricated in accordance with the principles presented herein, jets or nozzles can be implemented virtually anywhere within an electronic component. For example, consider a heat sink/thermal exchange structure built to include a significantly large surface area by employing wells or channels therein. Because of the ability to fabricate these nozzles with such very small size, nozzles may be implemented virtually anywhere within an electronic device. This embodiment shows electrospray jets oriented to electrospray in multiple directions to effectuate cooling on more than one surface of the heat sink/thermal exchange structure.

In some instances, the region in which electrospray is performed is the same region in which evaporation occurs. These two actions may be competitive, in that, evaporation may not occur at a sufficiently acceptable rate because the electrospraying is being performed in the same region. Therefore, in some embodiments, the thermal exchange surface may include a droplet movement mechanism to transport droplets received at a first location of the thermal exchange surface to a second location of the thermal exchange surface. In this way, evaporation may occur primarily in a region that is different and remote to the region in which electrospraying is performed.

There are a wide variety of means by which droplets may be transported across a surface of thermal exchange surface. Some possible means by which such transportation may be performed are described herein.

From certain perspectives, the mechanism of droplet manipulation relies on the surface energy gradient of droplets. Because of the surface energy gradient, the movement of droplets can be controlled. For example, droplets can be transported, merged, mixed, split, and formed in a controlled system. Some means of performing droplet manipulation include electrowetting (see references [1-6]), dielectrophoresis (see reference[7]), thermocapillary forces (see references [8-15]), chemical gradients (see references [16-20]), magnetic forces (see reference [21]), lateral vibration (see reference [22]), air pressure (see references [23-24]), and textured surfaces (see references [25-28]).

In a droplet manipulation system, the relative wettability between solid-liquid, solid-gas, and gas-liquid interfaces are locally changed. The hydrophobic surface becomes more hydrophobic and the shape of droplets becomes more spherical. The accompanied change is the creation of surface energy gradients on a surface on which droplets sit. Droplets have the tendency to move to a place in which the surface energy is the lowest. Therefore, those droplets can be smoothly manipulated to any expected directions on a surface with created surface energy gradients. As the invention primarily focuses on enhancing heat transfer performance in electrospray cooling, the detailed operation principles for different droplet manipulation techniques are not discussed. Only a subset (e.g., four) of these many possible droplet movement techniques are briefly discussed here, including the utilization of the thermocapillary force, the surface chemical gradient, the textured surface, and the vibration-induced inertial force.

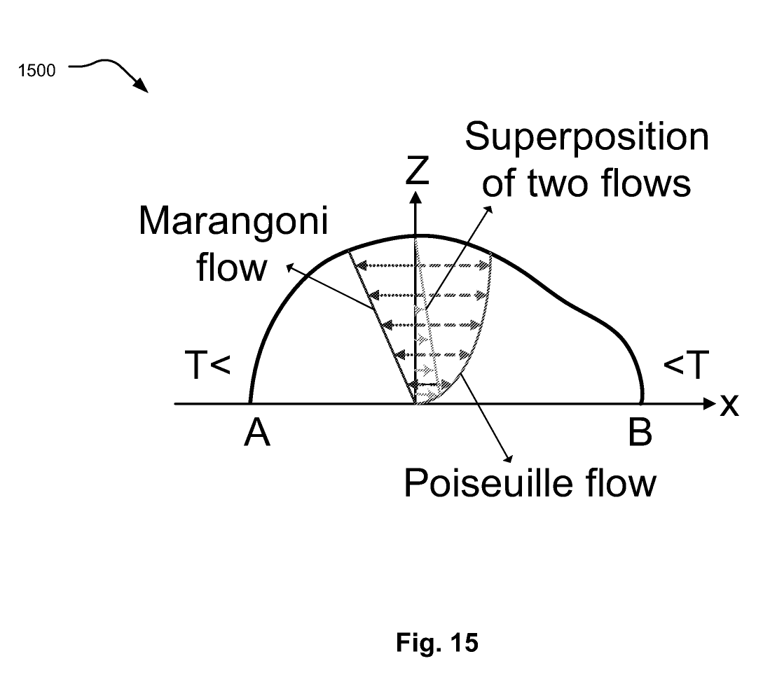

FIG. 15 illustrates an embodiment 1500 of flow inside of a droplet in accordance with the thermocapillary force.

Thermocapillary force: Due to the temperature difference, the thermocapillary force can be used to modify the surface tension at the liquid-gas interface. As the surface tension is inversely proportional to the temperature, by controlling the surface temperature gradient on which droplets sit, the droplets can then be guided. The Marangoni and the Poiseuille flows are the two primary flows inside a droplet when contacting with a surface with temperature gradient. The former is caused by the reduction of the free surface stress of the droplet due to the surface tension gradient induced by temperature difference. The latter is due to the pressure gradient of the non-uniform thickness of a droplet. The Marangoni flow tends to drive the droplet from hotter region to the cooler region while the Poiseuille flow tends to drive the droplet in opposite direction. Hence, the moving direction of the droplet is the superposition of these two flows, as is shown in FIG. 15. By controlling these two flows inside the droplet, the droplet can be manipulated from the cooler region toward the hotter area.

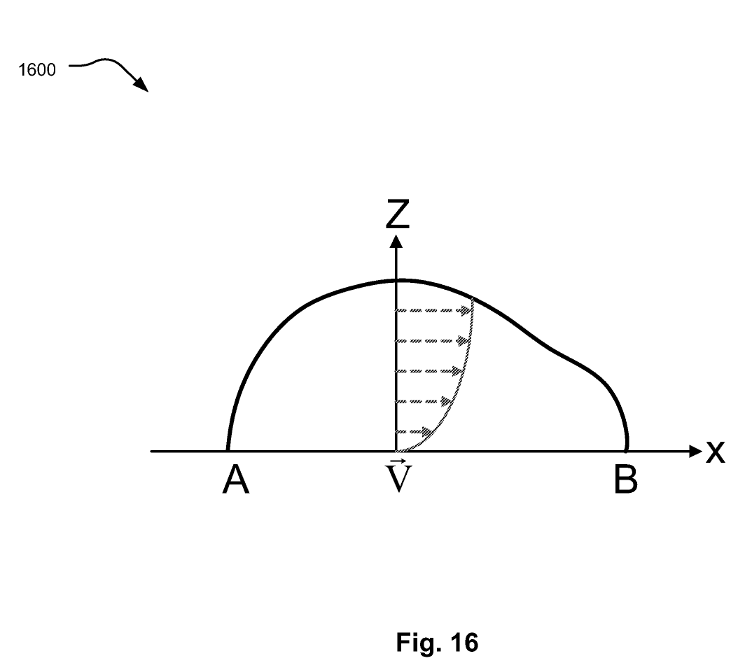

FIG. 16 illustrates an embodiment 1600 of a droplet on a surface with chemical gradient.

Surface chemical gradient: The wetting feature of a surface is determined by the surface chemical compositions. Droplets can be dragged by surface tension towards the more wettable area on a surface because of the surface chemical gradient, as is displayed in FIG. 16.

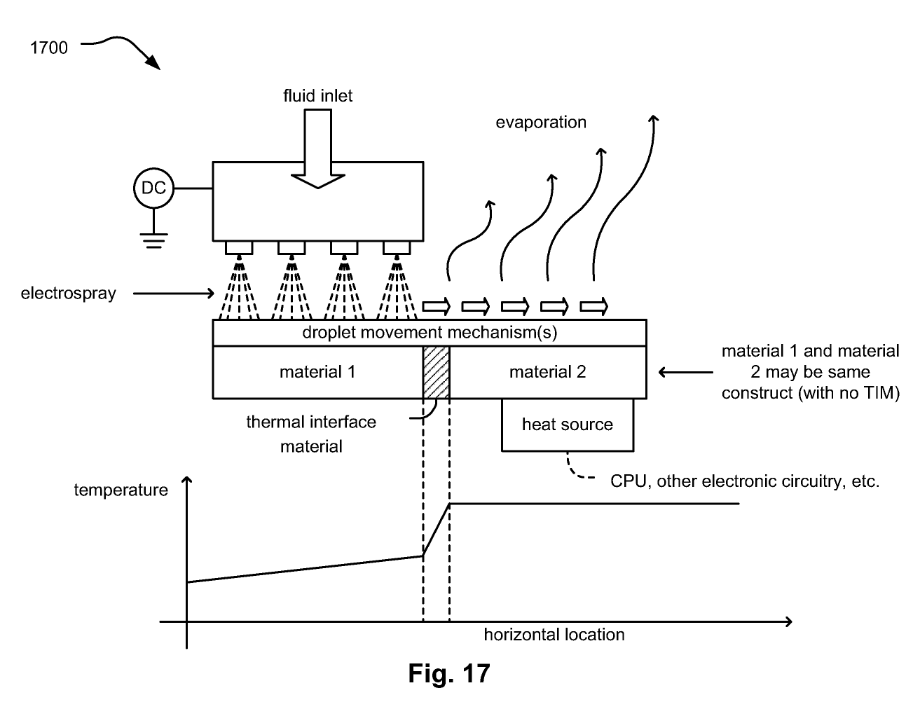

FIG. 17 illustrates an embodiment of an ESC device 1700 that includes one or more droplet movement mechanisms. This diagram shows an ESC device that operates using droplet movement mechanism to transport droplets received at a first location so that evaporation primarily occurs at a second location.

In the ESC device 1700, droplets arrive at a first portion of the thermal exchange surface that is separated from a second portion of the thermal exchange surface; these portions of the thermal exchange surface (e.g., shown as material 1 and material 2) are separated by a thermal interface material. This structure is composed of a thermal conductivity layer and two separate materials (each having respective thermal conductivity).

The thermal conduction layer is composed of material 1 and material 2 instead of only one material. The created temperature gradient over the heat exchange surface may therefore be controlled and modified based on the use of more than one type of material. In this embodiment, material 1 has relatively lower thermal conductivity while material 2 has a relatively higher thermal conductivity (when compared to material 1). Again, these two materials are connected by one or more thermal interface materials (e.g., thermal grease, or some other type of material) to generate temperature distribution over the heat exchange surface.

It is also noted that, within an embodiment that employs one or more droplet movement mechanisms, the thermal exchange surface need not necessarily be composed of more than one material. That is to say, the principles of droplet movement may be performed also within an ESC device whose thermal exchange surface is composed of only one material.

In this embodiment, material 2 is placed on top of the heat source (e.g., a CPU, an integrated circuit, another type of electronic device, etc.). Consequently, the desired temperature distribution, lower (left) to higher (right) temperature gradient, from material 1 to material 2 is established, as displayed in the bottom portion of FIG. 17. The temperature in material 2 is much higher than that in material 1; hence, most of the heat will be dissipated above the top surface of material 2.

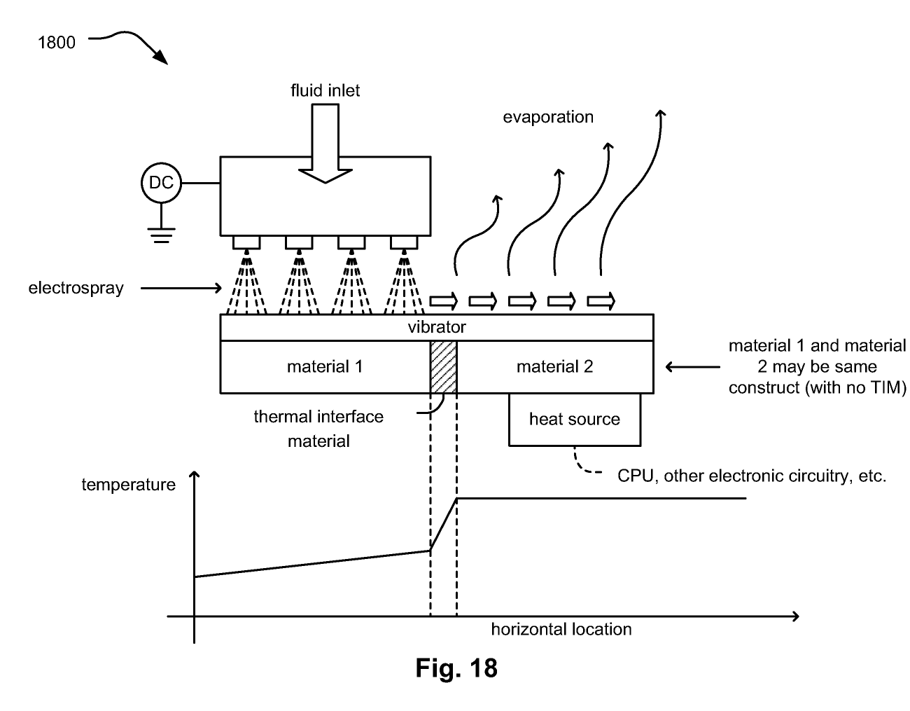

FIG. 18 illustrates an embodiment of an ESC device 1800 that includes a vibrator based droplet movement mechanism. In this embodiment, the droplet movement mechanism of the thermal exchange surface includes a vibrator that vibrates the thermal exchange surface thereby transporting the droplets received at the first location of the thermal exchange surface to the second location of the thermal exchange surface.

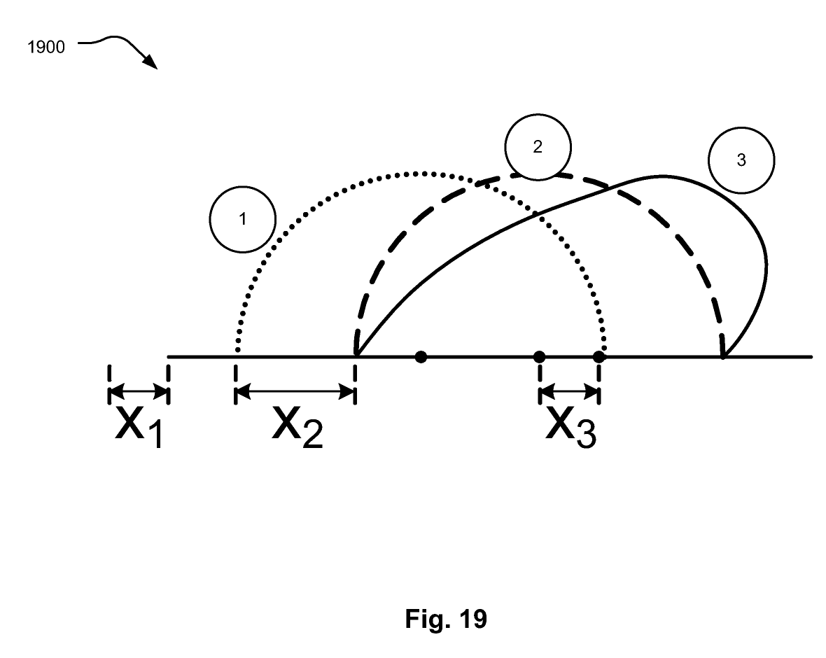

FIG. 19 illustrates an embodiment 1900 of movement of a droplet induced by vibration of a surface.

Vibration-induced inertial force: When a droplet sits on a periodic lateral vibrating surface, as illustrated in FIG. 19, it experiences an inertial force and attempts to move to a new position where the total energy is the lowest. As depicted, encircled reference numeral 1 shows the undisturbed ideal profiles of the droplet, and encircled reference numeral 2 shows the new ideal profile of the droplet. The frictional forces acting at phase contact lines as well as in the bulk of the drop retard this motion. The net force causes the drop to deform, as depicted by encircled reference numeral 3. On the other hand, the Laplace pressure acting inside the deformed drop attempts to restore it to its original shape. Therefore, the droplet can be regarded as a spring. The exact deformation that the droplet experiences depends on its spring characteristic and the difference between the inertial and hysteretic forces acting on the droplet. In FIG. 19, x₁ indicates the displacement of the surface during vibration, x₂ is the displacement of the contact line with respect to the plate, and x₃ is the displacement of the center of mass of the droplet. Displacements, x₂ and x₃, could be either positive or negative.

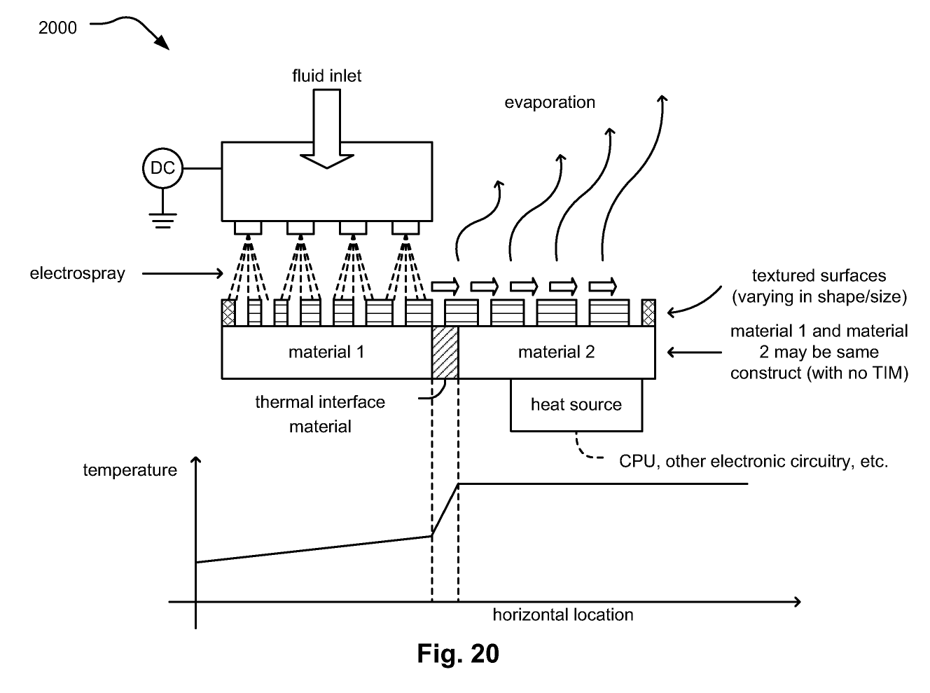

FIG. 20 illustrates an embodiment of an ESC device 2000 that includes a textured surface based droplet movement mechanism. In this embodiment, the droplet movement mechanism of the thermal exchange surface includes a textured surface across which droplets received at the first location of the thermal exchange surface are transported to the second location of the thermal exchange surface. This diagram shows an ESC device using droplets manipulation on the confined textured surfaces for heat transfer applications.

In this embodiment, different hydrophobic textured surfaces are at the top of the thermal insulation layer. FIG. 20 depicts the configuration of different confined textured surfaces and both of these surfaces, and the surfaces may also be chemically treated to cause chemical gradients (e.g., such that the droplet movement mechanism of the thermal exchange surface includes more than one droplet movement mechanism: a textured surface in conjunction with chemical treatment of the surfaces of the thermal exchange surface).

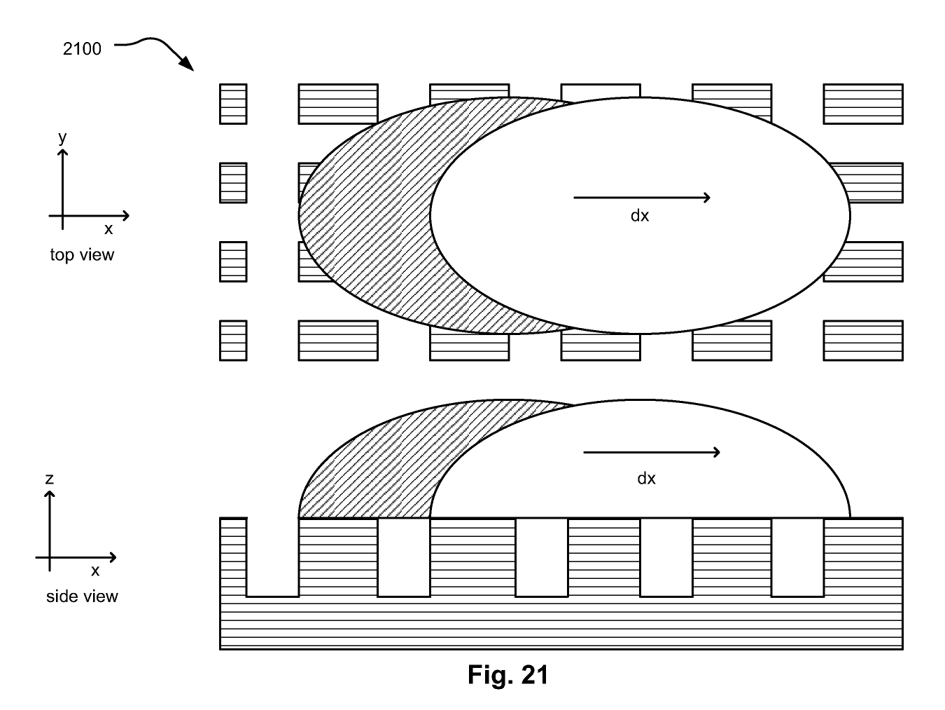

FIG. 21 illustrates an embodiment 2100 of movement of a droplet on a textured surface.

Textured surface: Surface energy gradient can be created using textured surfaces. As a result, droplets can be transported from a high surface energy region to a low surface energy region. The surface energy of the textured surface is determined by the contact area of the droplet on the surface. The larger the contact area of the droplet on the surface, then lower is the surface energy of the contacted surface. FIG. 21 illustrates the movement of a droplet on a textured surface. The droplet is manipulated from the left region with higher surface energy to the right region with lower surface energy (e.g., as shown by vector dx). That is, the droplets are transported toward the surface with larger contact area.

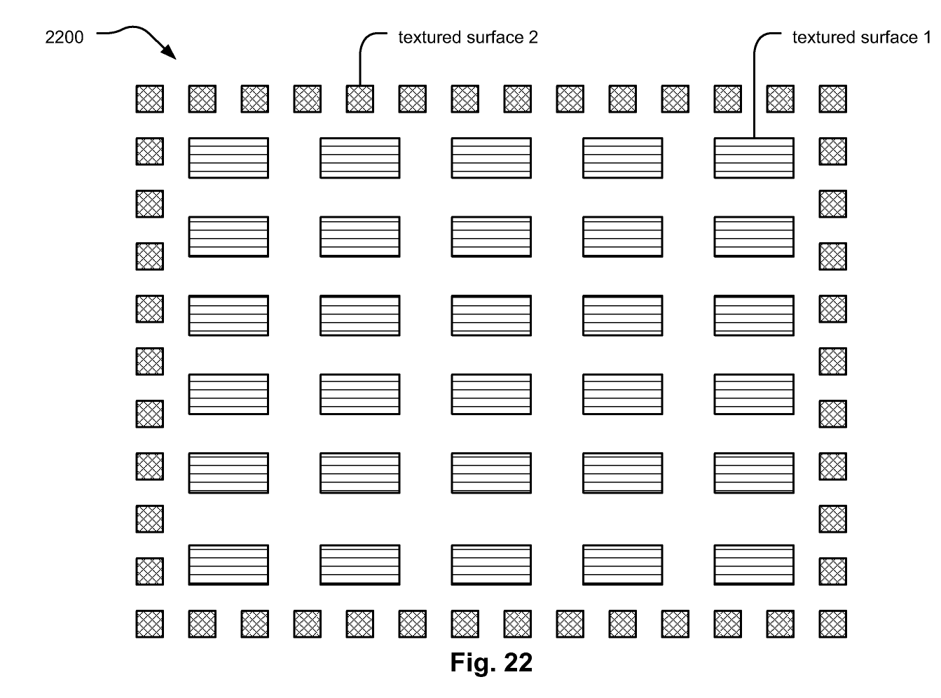

FIG. 22 illustrates an embodiment 2200 of a top view of textured surface that is operative to effectuate droplet movement. Textured surface 1 is the major surface area two-phase heat transfer occurs and also it occupies most of the top surface of the textured surfaces. To have the heat transfer ability, textured surface 2 (shown as being above and along the periphery of the top surface of the thermal insulation layer) is designed to confine the charged droplets within the top surface of the textured surface 1. Therefore, the density of the texture structure of the textured surface 2 is lower than that of the textured surface 1.

An electrospray nozzle array is placed a distance above the top surface of material 1. A high DC voltage is applied between the nozzle array and the material 1 to create the Columbic force to overcome the intra-molecular forces of the fluid. Therefore, fine, charged droplets of substantially similar size are generated from the tips of the nozzle array, as depicted in FIG. 20.

Those charged droplets are then accelerated by the electrostatic force toward the textured surface 1 (of FIG. 22), which also serves as a thermal exchange surface. On this surface, charged droplets are manipulated from the surface above the top of material 1 to continue to the surface above the top of material 2, as is shown in FIG. 20, due to the droplets manipulation technologies, including thermocapillary force, and the textured surface (and also in accordance with the surface chemical gradient, if desired, in a multiple droplet movement mechanism embodiment). During this process, the majority of the heat is absorbed by phase change of droplets and evaporation primarily happens at the textured surface 1, especially above the surface of material 2, as shown in FIG. 20. In this way, the droplets being emitted from the nozzle array will not be influenced by the opposite motion of the vapor; thus, efficient heat transfer may be maintained at an optimally desired performance.

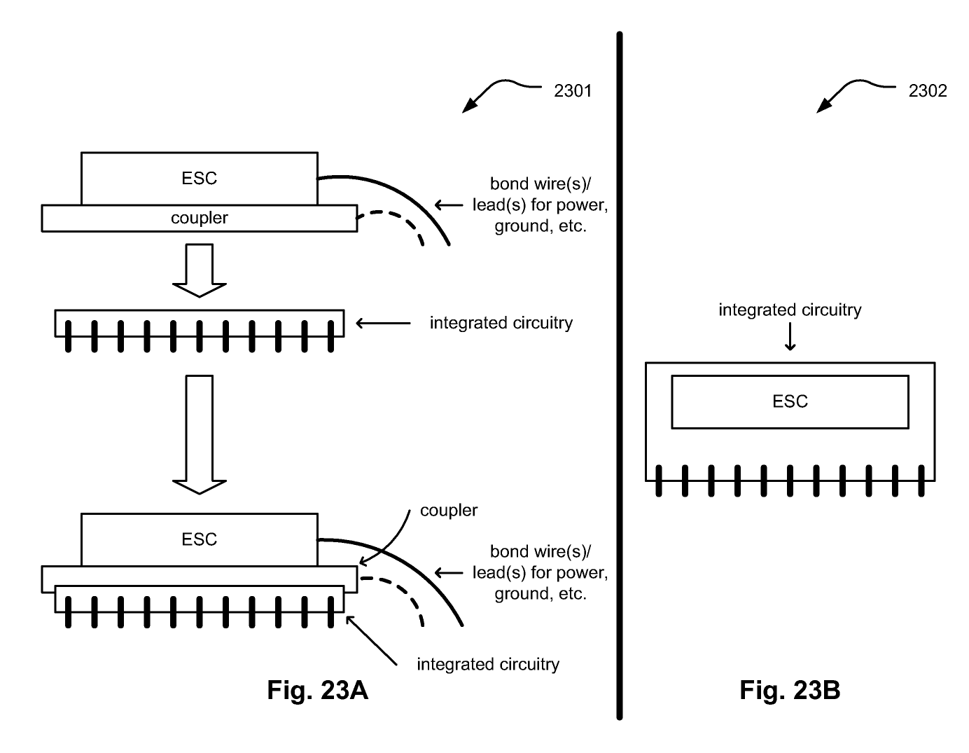

FIG. 23A illustrates an embodiment of an ESC device 2301 that includes a coupler and is operative to couple to an integrated circuitry. The ESC device 2301 includes a coupler that is operative to couple the thermal exchange surface of the ESC device 2301 to another electronic device. For example, the coupler is operative to couple the ESC device to an encapsulated, electronic circuitry. The coupler may be any desired mechanism that allows the ESC device 2301 to be connected to an electronic device. The coupler may be integrated into the ESC device 2301, or it may be attached thereto. It is also noted that one or more bond wires, leads, or other electrical connectivity means may be implemented within either the ESC device 2301, or the coupler thereof, to allow connectivity of various signals with the integrated circuit and/or a circuit board on which the integrated circuit may be deployed. These one or more bond wires, leads, or other electrical connectivity means may connect to one or more locations on such a circuit board or they may be connected to one or more of the pins of the integrated circuit.

In such an embodiment as shown in this diagram, the coupler of the ESC device 2301 allows connectivity to an integrated circuit. Such an ESC 2301 may be manufactured and distributed for use and deployment within existing electronic devices. Stated another way, such an ESC 2301 with a coupler may be procured and installed by an end user within an existing electronic device to allow for thermal management of one or more components therein. This allows for a backward compatibility within existing, legacy type electronic devices while still providing for the thermal management capabilities as provided in accordance with the ESC principles presented herein.

FIG. 23B illustrates an embodiment of an ESC device 2302 that is integrated within an integrated circuitry. This embodiment, in contrast to the previous embodiment, includes an ESC device integrated within an integrated circuitry. Such an ESC device may be fabricated within such an integrated circuitry, and as such an integrated circuitry is deployed, it inherently includes such thermal management capabilities.

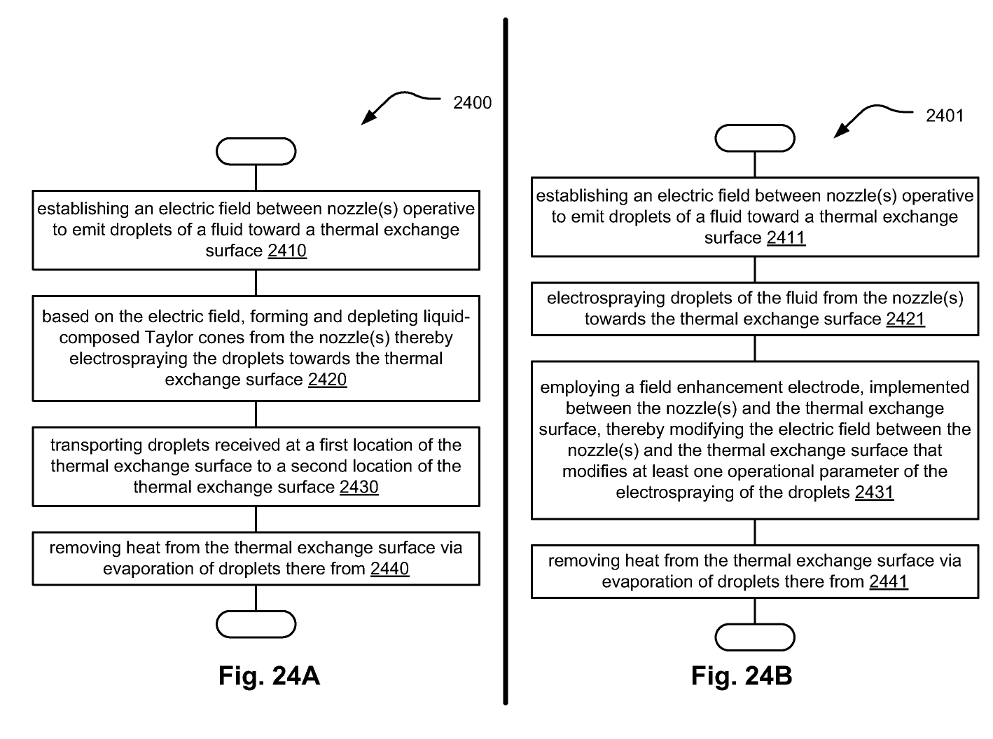

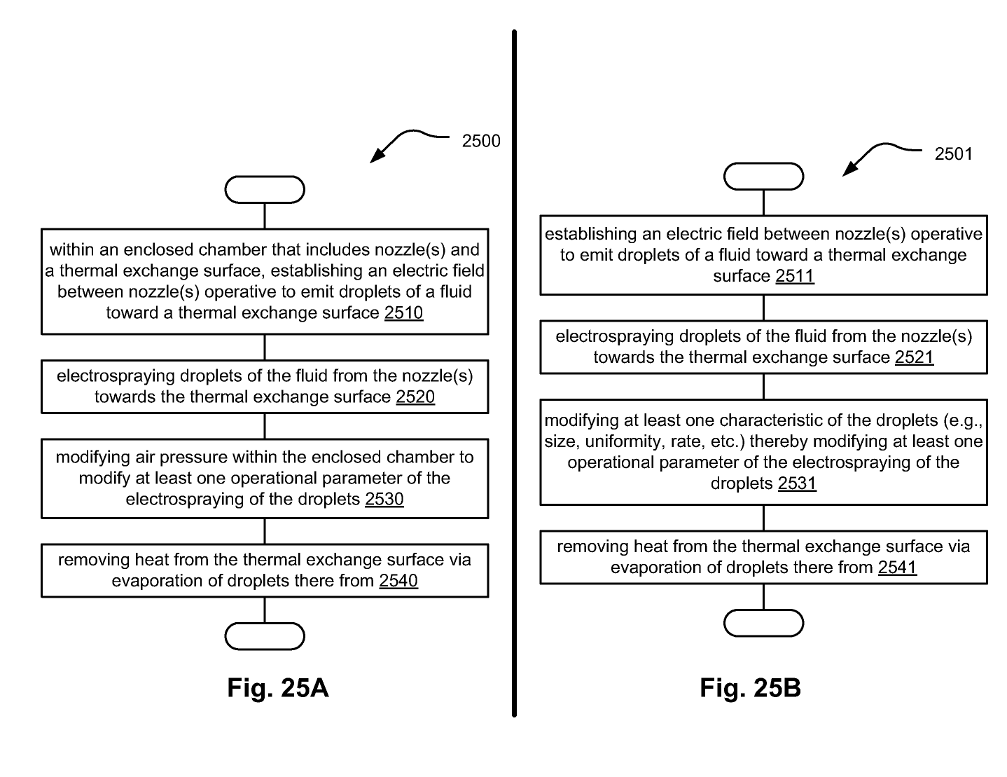

FIG. 24A illustrates an embodiment of a method 2400 for performing electrospray evaporative cooling.

Referring to method 2400 of FIG. 24A, the method 2400 begins by establishing an electric field between one or more nozzles that are operative to emit droplets of a fluid toward a thermal exchange surface, as shown in a block 2410. Based on the electric field, the method 2400 continues by forming and depleting liquid-composed Taylor cones from the one or more nozzles thereby electrospraying the droplets towards the thermal exchange surface, as shown in a block 2420.

The method 2400 then operates by transporting droplets received at a first location of the thermal exchange surface to a second location of the thermal exchange surface, as shown in a block 2430. This may be performed using one or more droplet movement mechanisms. Also, this transportation of the droplets received at the first location of the thermal exchange surface allows for evaporation to be performed primarily at a location that is different than the location at which the droplets arrive at the thermal exchange surface. The method 2400 continues by removing heat from the thermal exchange surface via evaporation of droplets there from, as shown in a block 2440.

FIG. 24B, FIG. 25A, and FIG. 25B illustrate alternative embodiments 2401, 2500, and 2501, respectively, of a method for performing electrospray evaporative cooling.

Referring to method 2401 of FIG. 24B, the method 2401 begins by establishing an electric field between one or more nozzles that are operative to emit droplets of a fluid toward a thermal exchange surface, as shown in a block 2411. The method 2401 then operates by electrospraying droplets of the fluid from the one or more nozzles towards the thermal exchange surface, as shown in a block 2421.

The method 2401 continues by employing a field enhancement electrode, implemented between the one or more nozzles and the thermal exchange surface, thereby modifying the electric field between the one or more nozzles and the thermal exchange surface that modifies at least one operational parameter of the electrospraying of the droplets, as shown in a block 2431. For example, the size of the droplets, uniformity of the droplets, the rate of delivery of the droplets, or some other operational parameter may be modified by the modification of the electric field between the one or more nozzles and the thermal exchange surface. The method 2401 then operates by removing heat from the thermal exchange surface via evaporation of droplets there from, as shown in a block 2441.

Referring to method 2500 of FIG. 25A, within an enclosed chamber that includes one or more nozzles and a thermal exchange surface, the method 2500 begins by establishing an electric field between one or more nozzles operative to emit droplets of a fluid toward a thermal exchange surface, as shown in a block 2510.

The method 2500 continues by electrospraying droplets of the fluid from the one or more nozzles towards the thermal exchange surface, as shown in a block 2520. The method 2500 then operates by modifying air pressure within the enclosed chamber to modify at least one operational parameter of the electrospraying of the droplets, as shown in a block 2530. This may be performed using a pressure control module in some embodiments. The method 2500 continues by removing heat from the thermal exchange surface via evaporation of droplets there from, as shown in a block 2540.

Referring to method 2501 of FIG. 25B, the method 2501 begins by establishing an electric field between one or more nozzles that are operative to emit droplets of a fluid toward a thermal exchange surface, as shown in a block 2511. The method 2501 then operates by electrospraying droplets of the fluid from the one or more nozzles towards the thermal exchange surface, as shown in a block 2521.

The method 2501 continues by modifying at least one characteristic of the droplets (e.g., size, uniformity, rate, etc.) thereby modifying at least one operational parameter of the electrospraying of the droplets, as shown in a block 2531. For example, this may involve any one or more of modifying the pressure of an enclosed chamber, modifying an electric field (e.g., by using an enhancement electrode), modifying some other operational parameter, etc. In some embodiments, two or more operational parameters may simultaneously be modified in accordance with the method 2501. The method 2501 then operates by removing heat from the thermal exchange surface via evaporation of droplets there from, as shown in a block 2541.

It is noted that the various modules (e.g., integrated circuitries, pressure control modules, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory, random access memory, volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

### REFERENCES

[1] M. G. Pollack, A. D. Shenderov, and R. B. Fair, “Electrowetting-Based Actuation of Droplets for Integrated Microfluidics,” Lab on A Chip, vol. 2, no. 2, pp. 96-101, 2002.
[2] M. Washizu, “Electrostatic Actuation of Liquid Droplets for Microreactor Applications,” IEEE Transactions on Industry Applications, vol. 34, no. 4, pp. 732-737, July 1998.
[3] S. K. Cho, H. J. Moon, and C. J. Kim, “Creating, Transporting, Cutting, and Merging Liquid Droplets by Electrowetting-Based Actuation for Digital Microfluidic Circuits,” Journal of Microelectromechanical Systems, vol. 12, no. 1, pp. 70-80, February 2003.
[4] F. Mugele and J. C. Baret, “Electrowetting: From Basics to Applications,” Journal of Physics-Condensed Matter, vol. 17, no. 28, pp. R705-R774, July 2005.
[5] F. Mugele, J. C. Baret, and D. Steinhauser, “Microfluidic Mixing Through Electrowetting-Induced Droplet Oscillations,” Applied Physics Letters, vol. 88, no. 20, May 2006.
[6] M. G. Pollack, R. B. Fair, and A. D. Shenderov, “Electrowetting-Based Actuation of Liquid Droplets for Microfluidic Applications,” Applied Physics Letters, vol. 77, no. 11, pp. 1725-1726, September 2000.
[7] P. R. C. Gascoyne, J. V. Vykoukal, J. A. Schwartz, T. J. Anderson, D. M. Vykoukal, K. W. Current, C. McConaghy, F. F. Becker, and C. Andrews, “Dielectrophoresis-Based Programmable Fluidic Processors,” Lab on A Chip, vol. 4, no. 4, pp. 299-309, 2004.
[8] A. A. Darhuber and S. M. Troian, “Principles of Microfluidic Actuation by Modulation of Surface Stresses,” Annual Review of Fluid Mechanics, vol. 37, pp. 425-455, 2005.
[9] F. Brochard, “Motions of Droplets on Solid-Surfaces Induced by Chemical Or Thermal-Gradients,” Langmuir, vol. 5, no. 2, pp. 432-438, March 1989.
[10] J. B. Brzoska, F. Brochardwyart, and F. Rondelez, “Motions of Droplets on Hydrophobic Model Surfaces Induced by Thermal-Gradients,” Langmuir, vol. 9, no. 8, pp. 2220-2224, August 1993.
[11] A. A. Darhuber, J. M. Davis, S. M. Troian, and W. W. Reisner, “Thermocapillary Actuation of Liquid Flow on Chemically Patterned Surfaces,” Physics of Fluids, vol. 15, no. 5, pp. 1295-1304, May 2003.
[12] A. A. Darhuber, J. P. Valentino, J. M. Davis, S. M. Troian, and S. Wagner, “Microfluidic Actuation by Modulation of Surface Stresses,” Applied Physics Letters, vol. 82, no. 4, pp. 657-659, January 2003.
[13] M. Ford and A. Nadim, “Thermocapillary Migration of an Attached Drop on Solid Surface,” Physics of Fluids, vol. 6, no. 9, pp. 3183-3185, 1994.
[14] T. S. Sammarco and M. A. Burns, “Thermocapillary Pumping of Discrete Drops in Microfabricated Analysis Devices,” Aiche Journal, vol. 45, no. 2, pp. 350-366, February 1999.
[15] Y. T. Tseng, F. G. Tseng, Y. F. Chen, and C. C. Cheng, “Fundamental Studies on Micro-Droplet Movement by Marangoni and Capillary Effects,” Sensors and Actuators A-Physical, vol. 114, no. 2-3, pp. 292-301, September 2004.
[16] C. D. Bain, G. D. Burnetthall, and R. R. Montgomerie, “Rapid Motion of Liquid-Drops,” Nature, vol. 372, no. 6505, pp. 414-415, December 1994.
[17] M. K. Chaudhury and G. M. Whitesides, “How to Make Water Run Uphill,” Science, vol. 256, no. 5063, pp. 1539-1541, June 1992.
[18] S. Daniel and M. K. Chaudhury, “Rectified Motion of Liquid Drops on Gradient Surfaces Induced by Vibration,” Langmuir, vol. 18, no. 9, pp. 3404-3407, April 2002.
[19] K. Ichimura, S. K. Oh, and M. Nakagawa, “Light-Driven Motion of Liquids on a Photoresponsive Surface,” Science, vol. 288, no. 5471, pp. 1624-1626, June 2000.
[20] D. F. Dossantos and T. Ondarcuhu, “Free-Running Droplets,” Physical Review Letters, vol. 75, no. 16, pp. 2972-2975, October 1995.
[21] J. R. Dorvee, A. M. Derfus, S. N. Bhatia, and M. J. Sailor, “Manipulation of Liquid Droplets Using Amphiphilic, Magnetic One-Dimensional Photonic Crystal Chaperones,” Nature Materials, vol. 3, no. 12, pp. 896-899, December 2004.
[22] S. Daniel, M. K. Chaudhury, and P. G. de Gennes, “Vibration-Actuated Drop Motion on Surfaces for Batch Microfluidic Processes,” Langmuir, vol. 21, no. 9, pp. 4240-4248, April 2005.
[23] K. Handique, D. T. Burke, C. H. Mastrangelo, and M. A. Burns, “Nanoliter Liquid Metering in Microchannels Using Hydrophobic Patterns,” Analytical Chemistry, vol. 72, no. 17, pp. 4100-4109, September 2000.
[24] K. Hosokawa, T. Fujii, and I. Endo, “Handling of Picoliter Liquid Samples in a Poly(Dimethylsiloxane)-Based Microfluidic Device,” Analytical Chemistry, vol. 71, no. 20, pp. 4781-4785, October 1999.
[25] O. Sandre, L. Gorre-Talini, A. Ajdari, J. Prost, and P. Silberzan, “Moving Droplets on Asymmetrically Structured Surfaces,” Physical Review e, vol. 60, no. 3, pp. 2964-2972, September 1999.
[26] D. Quere and A. Ajdari, “Liquid Drops: Surfing the Hot Spot,” Nature Materials, vol. 5, no. 6, pp. 429-430, June 2006.
[27] A. Shastry, M. J. Case, and K. F. Bohringer, “Directing Droplets Using Microstructured Surfaces,” Langmuir, vol. 22, no. 14, pp. 6161-6167, July 2006.
[28] A. Shastry, D. Taylor, and K. F. Bohringer, “Micro-Structured Surface Ratchets for Droplet Transport,” 2007, pp. 1353-1356.

What is claimed is:

1. An apparatus, comprising:
a nozzle, energized with a first voltage, that is operative to emit droplets of a liquid; and
a thermal exchange surface, energized with a second voltage, implemented to receive at least some of the droplets emitted from the nozzle; and wherein:
at least one operational parameter corresponding to the emission of the droplets from the nozzle is based on a voltage difference between the first voltage and the second voltage; and
evaporation of droplets from the thermal exchange surface removes heat there from.

2. The apparatus of claim 1, wherein:
the at least one operational parameter corresponding to the emission of the droplets from the nozzle, that is based on the voltage difference between the first voltage and the second voltage, corresponds to at least one of:
a rate of emission of the droplets emitted from the nozzle;
a size of the droplets emitted from the nozzle; and
a distribution or uniformity of the droplets emitted from the nozzle.

3. The apparatus of claim 1, further comprising:
a plurality of nozzles, and wherein:
the nozzle is one of the plurality of nozzles;
each of the plurality of nozzles is energized with the first voltage; and
the plurality of nozzles is cooperatively operative to emit the droplets.

4. The apparatus of claim 1, further comprising:
a plurality of nozzles, and wherein:
the nozzle is one of the plurality of nozzles;
each of the plurality of nozzles is energized with the first voltage;
a first subset of the plurality of nozzles is capped; and
a second subset of the plurality of nozzles is cooperatively operative to emit the droplets.

5. The apparatus of claim 1, further comprising:
a field enhancement electrode, energized with a third voltage and implemented between the nozzle and the thermal exchange surface, that is operative to modify an electric field between the nozzle and the thermal exchange surface.

6. The apparatus of claim 1, wherein:
the thermal exchange surface includes a droplet movement mechanism to transport droplets received at a first location of the thermal exchange surface to a second location of the thermal exchange surface.

7. The apparatus of claim 6, wherein:
the droplet movement mechanism of the thermal exchange surface includes a textured surface across which droplets received at the first location of the thermal exchange surface are transported to the second location of the thermal exchange surface.

8. The apparatus of claim 6, wherein:
the droplet movement mechanism of the thermal exchange surface includes a vibrator that vibrates the thermal exchange surface thereby transporting the droplets received at the first location of the thermal exchange surface to the second location of the thermal exchange surface.

9. The apparatus of claim 1, further comprising:
an electronic circuitry that is coupled to the thermal exchange surface; and wherein:
heat is removed from the electronic circuitry via the evaporation of the droplets from the thermal exchange surface.

10. The apparatus of claim 1, further comprising:
an electronic circuitry that is coupled to the thermal exchange surface; and wherein:
heat is removed from the electronic circuitry via the evaporation of the droplets from the thermal exchange surface;
the thermal exchange surface includes a first material having a first thermal conductivity, a second material having a second thermal conductivity, and a thermal interface material interposed between and coupled to each of the first material and the second first material;
the first material of the thermal exchange surface is implemented to receive the at least some of the droplets emitted from the nozzle; and
the electronic circuitry is coupled to the second material of the thermal exchange surface.

11. The apparatus of claim 1, further comprising:
a coupler that is operative to couple the thermal exchange surface to an encapsulated, electronic circuitry.

12. The apparatus of claim 1, wherein:
the liquid includes electrolytes such that the liquid has conductivity; and
in response to the voltage difference between the first voltage and the second voltage, the liquid forms a Taylor cone at the nozzle from which the droplets are emitted.

13. The apparatus of claim 1, further comprising:
a reservoir, coupled to the nozzle, that holds the liquid; and
a condenser, coupled to the reservoir, that is operative to capture the evaporated droplets and provide the evaporated droplets to the reservoir.

14. The apparatus of claim 1, further comprising:
an enclosed chamber that surrounds the nozzle and the thermal exchange surface and a region there between; and
a pressure control module, coupled to the enclosed chamber, that is operative to modify air pressure within the enclosed chamber.

15. The apparatus of claim 1, further comprising:
a plurality of nozzles, and wherein:
the nozzle is one of the plurality of nozzles;
the plurality of nozzles is arranged in an array that is constructed of a dielectric material; and
ends of each of the plurality of nozzles align along a surface of the dielectric material.

16. An apparatus, comprising:
a plurality of nozzles, energized with a first voltage, such that at least some of the plurality of nozzles are operative to emit droplets of a liquid;
a thermal exchange surface, energized with a second voltage, implemented to receive at least some of the droplets emitted from the plurality of nozzles; and
an electronic circuitry that is coupled to the thermal exchange surface; and wherein:
at least one operational parameter corresponding to the emission of the droplets from the plurality of nozzles is based on a voltage difference between the first voltage and the second voltage;
the thermal exchange surface includes a droplet movement mechanism to transport droplets received at a first location of the thermal exchange surface to a second location of the thermal exchange surface; and
heat is removed from the electronic circuitry via evaporation of the droplets from the thermal exchange surface.

17. The apparatus of claim 16, wherein:
the at least one operational parameter corresponding to the emission of the droplets from the plurality of nozzles, that is based on the voltage difference between the first voltage and the second voltage, corresponds to at least one of:
a rate of emission of the droplets emitted from the plurality of nozzles;
a size of the droplets emitted from the plurality of nozzles; and
a distribution or uniformity of the droplets emitted from the plurality of nozzles.

18. The apparatus of claim 16, further comprising:
a field enhancement electrode, energized with a third voltage and implemented between the plurality of nozzles and the thermal exchange surface, that is operative to modify an electric field between the plurality of nozzles and the thermal exchange surface.

19. The apparatus of claim 16, wherein:
the droplet movement mechanism of the thermal exchange surface includes a textured surface across which droplets received at the first location of the thermal exchange surface are transported to the second location of the thermal exchange surface.

20. The apparatus of claim 16, wherein:
the droplet movement mechanism of the thermal exchange surface includes a vibrator that vibrates the thermal exchange surface thereby transporting the droplets received at the first location of the thermal exchange surface to the second location of the thermal exchange surface.

21. The apparatus of claim 16, wherein:
the thermal exchange surface includes a first material having a first thermal conductivity, a second material having a second thermal conductivity, and a thermal interface material interposed between and coupled to each of the first material and the second first material;
the first material of the thermal exchange surface is implemented to receive the at least some of the droplets emitted from the plurality of nozzles; and
the electronic circuitry is coupled to the second material of the thermal exchange surface.

22. The apparatus of claim 16, wherein:
the liquid includes electrolytes such that the liquid has conductivity; and
in response to the voltage difference between the first voltage and the second voltage, the liquid respectively forms a plurality of Taylor cones at the plurality of nozzles from which the droplets are emitted.

23. The apparatus of claim 16, further comprising:
a reservoir, coupled to the plurality of nozzles, that holds the liquid; and
a condenser, coupled to the reservoir, that is operative to capture the evaporated droplets and provide the evaporated droplets to the reservoir.

24. The apparatus of claim 16, further comprising:
an enclosed chamber that surrounds the plurality of nozzles and the thermal exchange surface and a region there between; and
a pressure control module, coupled to the enclosed chamber, that is operative to modify air pressure within the enclosed chamber.

25. The apparatus of claim 16, wherein:
the plurality of nozzles is arranged in an array that is constructed of a dielectric material; and
ends of each of the plurality of nozzles align along a surface of the dielectric material.

26. An apparatus, comprising:
a plurality of nozzles, energized with a first voltage, such that at least some of the plurality of nozzles are operative to emit droplets of a liquid;
a thermal exchange surface, energized with a second voltage, implemented to receive at least some of the droplets emitted from the plurality of nozzles;
a field enhancement electrode, energized with a third voltage and implemented between the plurality of nozzles and the thermal exchange surface, that is operative to modify an electric field between the plurality of nozzles and the thermal exchange surface; and
an electronic circuitry that is coupled to the thermal exchange surface; and wherein:
at least one operational parameter corresponding to the emission of the droplets from the plurality of nozzles is based on a voltage difference between the first voltage and the second voltage;
the thermal exchange surface includes a droplet movement mechanism to transport droplets received at a first location of the thermal exchange surface to a second location of the thermal exchange surface;
heat is removed from the electronic circuitry via evaporation of the droplets from the thermal exchange surface;
the thermal exchange surface includes a first material having a first thermal conductivity, a second material having a second thermal conductivity, and a thermal interface material interposed between and coupled to each of the first material and the second first material;
the first material of the thermal exchange surface is implemented to receive the at least some of the droplets emitted from the plurality of nozzles; and
the electronic circuitry is coupled to the second material of the thermal exchange surface.

27. The apparatus of claim 26, wherein:
the at least one operational parameter corresponding to the emission of the droplets from the plurality of nozzles, that is based on the voltage difference between the first voltage and the second voltage, corresponds to at least one of:
a rate of emission of the droplets emitted from the plurality of nozzles;
a size of the droplets emitted from the plurality of nozzles; and
a distribution or uniformity of the droplets emitted from the plurality of nozzles.

28. The apparatus of claim 26, wherein:
the liquid includes electrolytes such that the liquid has conductivity; and
in response to at least one of the voltage difference between the first voltage and the second voltage, a voltage difference between the first voltage and the third voltage, and a voltage difference between the second voltage and the third voltage, the liquid respectively forms a plurality of Taylor cones at the plurality of nozzles from which the droplets are emitted.

29. The apparatus of claim 26, further comprising:
a reservoir, coupled to the plurality of nozzles, that holds the liquid; and
a condenser, coupled to the reservoir, that is operative to capture the evaporated droplets and provide the evaporated droplets to the reservoir.

30. The apparatus of claim 26, further comprising:
an enclosed chamber that surrounds the plurality of nozzles and the thermal exchange surface and a region there between; and
a pressure control module, coupled to the enclosed chamber, that is operative to modify air pressure within the enclosed chamber.

31. The apparatus of claim 26, wherein:
the plurality of nozzles is arranged in an array that is constructed of a dielectric material; and
ends of each of the plurality of nozzles align along a surface of the dielectric material.
